(19) United States
(12) Patent Application Publication
(10) Pub. No.: US 2026/0268119 A1
(43) Pub. Date: Sep. 10, 2026

(54) Multi-Agent Artificial Intelligence Engine For Processing Cross-Domain Data

(71) Applicant: N1 Research LLC, Kingstown (VC)

(72) Inventor: Jean-Yves Sireau, Kowloon (HK)

(73) Assignee: N1 Research LLC, Kingstown (VC)

(21) Appl. No.: 19/090,511

(22) Filed: Mar. 26, 2025

Related U.S. Application Data
(60) Provisional application No. 63/766,631, filed on Mar. 4, 2025.

(51) Int. Cl. G06N 3/0455; G06N 3/047

(52) U.S. Cl. CPC G06N 3/0455; G06N 3/047

(57) ABSTRACT

A computer accesses input data from multiple data sources in different formats. The computer executes a multi-agent engine to detect anomalies in the input data by deploying a plurality of agents configured with specialized data processing models and coordinating, via a master analysis engine, information exchange between the plurality of agents. The computer performs root cause analysis by applying an iterative processing technique to identify causes of the detected anomalies in the input data. The iterative processing technique includes recursively analyzing detected anomalies to trace causal chains across the multiple data sources and generating a data structure mapping relationships between the detected anomalies and the identified causes. The data structure indicates a likelihood that at least one identified cause is associated with at least one detected anomaly. The computer generates an output indicating root causes identified through the root cause analysis.

### PRIORITY CLAIM

This application claims priority to U.S. Provisional Patent Application No. 63/766,631, filed on Mar. 4, 2025, and titled “Multi-Agent Artificial Intelligence Engine for Processing Cross-Domain Data,” the entirety of which is incorporated herein by reference.

### TECHNICAL FIELD

Embodiments pertain to computer architecture. Some embodiments relate to artificial intelligence. Some embodiments relate to a multi-agent artificial intelligence engine for processing cross-domain data.

### BACKGROUND

Computer systems that process and analyze data from multiple domains face significant technical challenges when attempting to integrate analyses across different specialized fields such as medicine, finance, management consulting, or information technology consulting. These systems struggle to effectively process large volumes of heterogeneous data - for example, a single complex medical case may involve processing over 5,000 biomarkers collected across decades, while maintaining the complex temporal relationships and interdependencies between data points. Some traditional computing schemes, even when using multiple specialized analysis modules, have been unable to effectively normalize data from diverse sources and formats into standardized data structures that preserve the semantic relationships needed for cross-domain analysis. Furthermore, some existing systems lack mechanisms for identifying and tracking dependencies between analyses performed by different specialized modules, leading to computational inefficiencies and incomplete analysis of indirect relationships.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition artificial intelligence program, in accordance with some embodiments.

FIG. 4 illustrates the feature-extraction process and classifier training, in accordance with some embodiments.

FIG. 5 is a block diagram of a computing machine, in accordance with some embodiments.

FIG. 6 is a block diagram of a multi-agent artificial intelligence system, in accordance with some embodiments.

FIG. 7 is a data flow diagram for data extraction and standardization, in accordance with some embodiments.

FIG. 8 is a block diagram of an artificial intelligence system, in accordance with some embodiments.

FIG. 9 is a data flow diagram for a root cause analysis workflow, in accordance with some embodiments.

FIG. 10 is a data flow diagram of an iterative feedback technique, in accordance with some embodiments.

FIG. 11 is a data flow diagram of a structured report generation technique, in accordance with some embodiments.

FIG. 12 is a block diagram of a privacy and compliance engine, in accordance with some embodiments.

FIG. 13 is a data flow diagram of a healthcare root cause analysis example, in accordance with some embodiments.

FIG. 14 is a data flow diagram of a financial root cause analysis example, in accordance with some embodiments.

FIG. 15 is a data flow diagram of a legal root cause analysis example, in accordance with some embodiments.

FIG. 16 is a flow chart of a multi-agent artificial intelligence technique for processing cross-domain data, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Aspects of the present technology may be implemented as part of a computer system. The computer system may be one physical machine, or may be distributed among multiple physical machines, such as by role or function, or by process thread in the case of a cloud computing distributed model. In various embodiments, aspects of the technology may be configured to run in virtual machines that in turn are executed on one or more physical machines. It will be understood by persons of skill in the art that features of the technology may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

As used herein, the term “memory subsystem” includes one or more memories, where each memory may be a computer-readable medium. A computer-readable medium may be a transitory computer-readable medium or a non-transitory computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “and/or” encompasses its plain and ordinary meaning and may refer to either an intersection or a union of sets of data. In a first example, the phrase “A and/or B” encompasses the intersection of A and B. In a second example, the phrase “A and/or B” encompasses the union of A and B.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

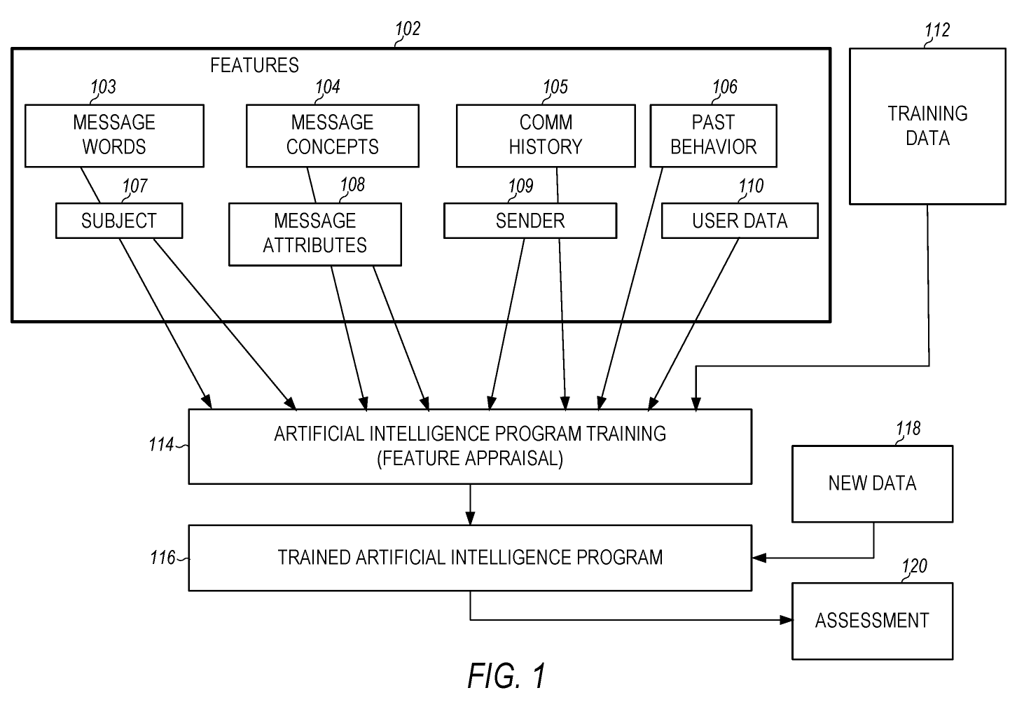

FIG. 1 illustrates the training and use of a machine-learning program, according to some example embodiments. In some example embodiments, machine-learning programs (MLPs), also referred to as machine-learning algorithms or tools, are utilized to perform operations associated with artificial intelligence (AI) tasks, such as image recognition or machine translation.

Artificial intelligence is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in artificial intelligence, a computer could be provided with examples of images of elephants and be trained to determine which images have and lack depictions of elephants, without the programmer encoding explicit instructions as to how to identify an elephant. Artificial intelligence explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in artificial intelligence are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the artificial intelligence tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Artificial intelligence (e.g., machine learning) techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the artificial intelligence technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other artificial intelligence algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n th epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs – having reached a performance plateau – the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

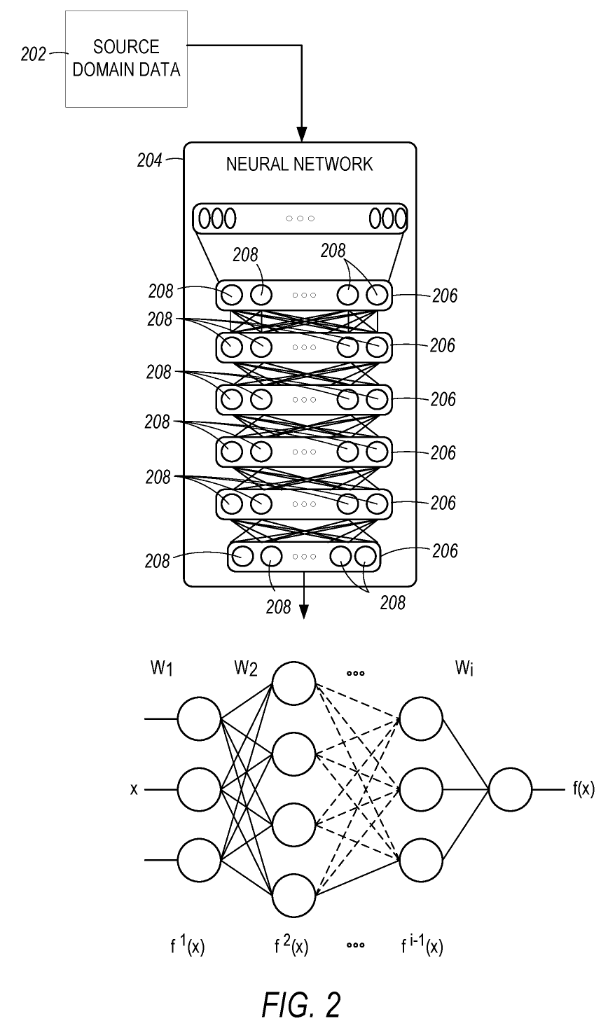

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W 1 , W 2 ,…,W i are applied to the input to each layer to arrive at f 1 (x), f 2 (x),…, f i-1 (x), until finally the output f(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly artificial intelligence, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node’s activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

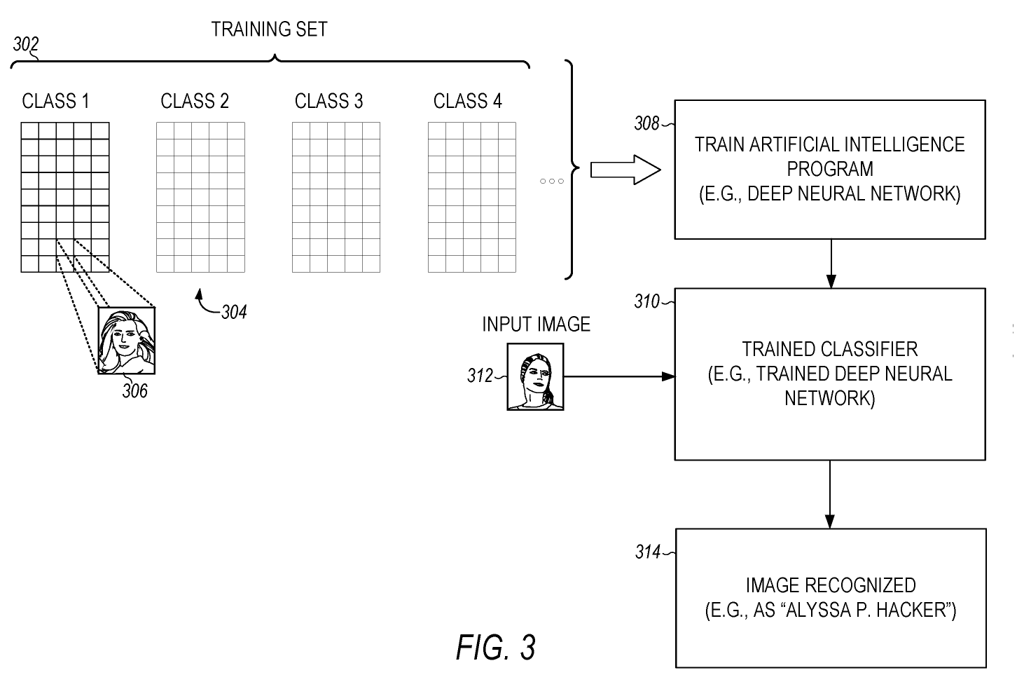

FIG. 3 illustrates the training of an image recognition artificial intelligence program, in accordance with some embodiments. The artificial intelligence program may be implemented at one or more computing machines. Block 302 illustrates a training set, which includes multiple classes 304. Each class 304 includes multiple images 306 associated with the class. Each class 304 may correspond to a type of object in the image 306 (e.g., a digit 0-9, a man or a woman, a cat or a dog, etc.). In one example, the artificial intelligence program is trained to recognize images of various persons (i.e., to map a photograph of a person to the person’s name), and each class 304 corresponds to each person, with each individual class 304 corresponding to an individual person (e.g., one class corresponds to Alyssa P. Hacker, one class corresponds to Ben Bitdiddle, etc.). At block 308 the artificial intelligence program is trained, for example, using a deep neural network. At block 310, the trained classifier (e.g., the trained deep neural network), generated by the training of block 308, receives an input image 312, and at block 314 the image is recognized. For example, if the image 312 is a photograph of Alyssa P. Hacker, the classifier recognizes the image as corresponding to Alyssa P. Hacker at block 314. The classifier may include a DNN, as illustrated by the circle with the circular arrows. While examples are described as recognizing images of persons (e.g., such as Alyssa P. Hacker or Ben Bitdiddle) other examples could be used to recognize information in medical images (e.g., x-rays) indicating medical conditions (e.g., osteoporosis, lung inflammation, or intestinal blockage).

FIG. 3 illustrates the training of a classifier, according to some example embodiments. An artificial intelligence algorithm is designed for recognizing faces, and a training set 302 includes data that maps a sample to a class 304 (e.g., a class includes all the images of purses). The classes may also be referred to as labels. Although implementations presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The artificial intelligence program is trained 308 with the training data to generate a classifier 310 operable to recognize images. In some example embodiments, the artificial intelligence program is a DNN.

When an input image 312 is to be recognized, the classifier 310 analyzes the input image 312 to identify the class (e.g., class 314) corresponding to the input image 312.

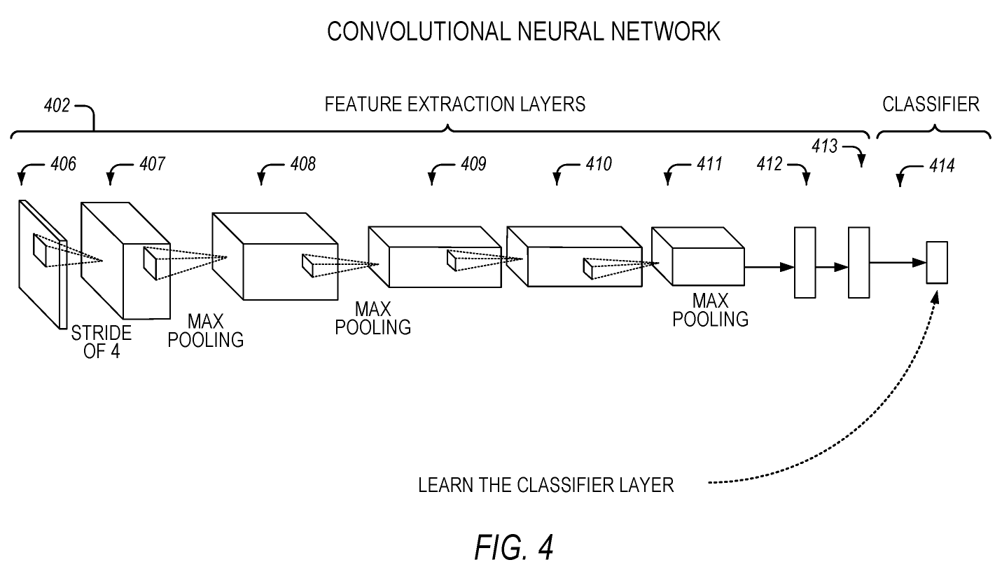

FIG. 4 illustrates a convolutional neural network, according to some example embodiments. Training a classifier of the convolutional neural network may be accomplished with feature extraction layers 402 and classifier layer 414. Each image is analyzed in sequence by a plurality of layers 406-413 in the feature-extraction layers 402.

With the development of deep convolutional neural networks, the focus in face recognition has been to learn a good face embedding-based classifier, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person’s identity. In the ideal case, there is a good face feature extractor (inter-class distance is always larger than the intra-class distance), and the KNN method is adequate to estimate the person’s identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

It should be noted that FIG. 4 illustrates one example of a neural network. Other neural networks may also be used in conjunction with the disclosed technology. Alternatively, some artificial intelligence techniques may leverage other technologies in addition to or in place of neural networks.

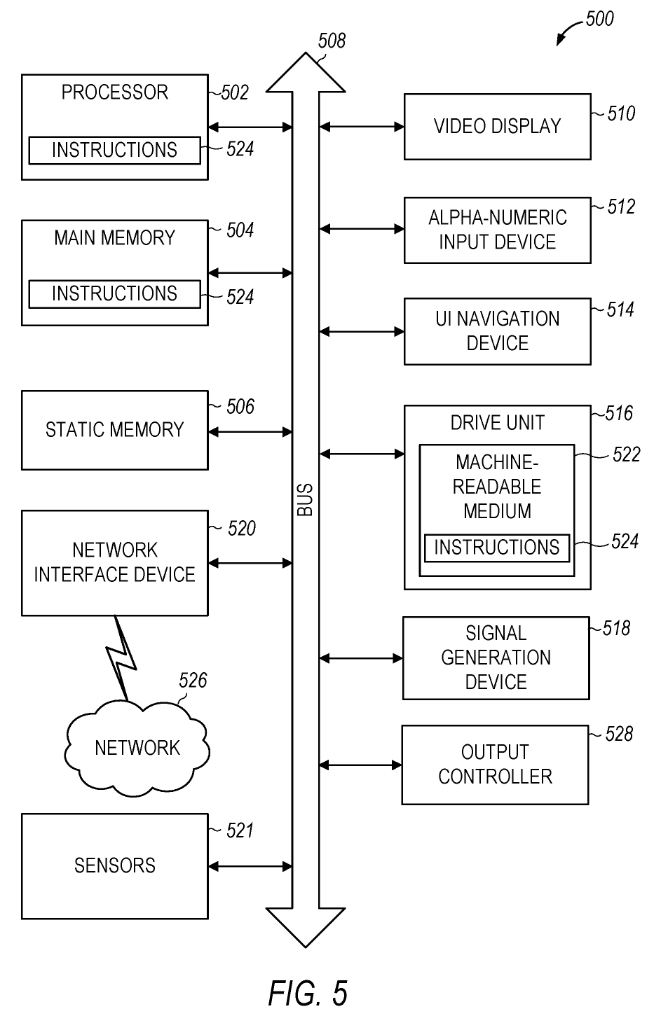

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

Computer systems that process and analyze data from multiple domains face significant technical challenges when attempting to integrate analyses across different specialized fields such as medicine, finance, management consulting, or information technology consulting. These systems struggle to effectively process large volumes of heterogeneous data - for example, a single complex medical case may involve processing over 5,000 biomarkers collected across decades, while maintaining the complex temporal relationships and interdependencies between data points. Some traditional computing schemes, even when using multiple specialized analysis modules, have been unable to effectively normalize data from diverse sources and formats into standardized data structures that preserve the semantic relationships needed for cross-domain analysis. Furthermore, some existing systems lack mechanisms for identifying and tracking dependencies between analyses performed by different specialized modules, leading to computational inefficiencies and incomplete analysis of indirect relationships. When attempting to refine analyses through iterative processing, some conventional systems either fail to converge or require manual intervention to coordinate between modules, making it computationally infeasible to process the full scope of available data. These technical limitations have meant that some computer systems can only process a small subset of available data, cannot effectively identify patterns that span multiple domains, and are unable to automatically refine analyses based on cross-domain dependencies, resulting in incomplete or inaccurate analytical outputs.

While some schemes employ multiple specialized modules to analyze different data domains, these schemes may function as isolated analytical silos that merely aggregate individual outputs without recognizing cross-domain interdependencies. Such schemes lack the ability to identify complex causal relationships that span multiple domains, as they might not be able to effectively coordinate analyses between specialized components or iteratively refine their findings based on cross-domain insights. Furthermore, some root cause analysis schemes may apply a single analytical methodology uniformly across all types of anomalies, regardless of the specific characteristics of the data or the domains involved, leading to suboptimal analytical outcomes when addressing complex, multi-domain problems.

Some schemes for multi-domain analysis have also struggled with data standardization challenges, particularly in preserving crucial temporal relationships and semantic context when processing heterogeneous data sources. These systems typically normalize data in ways that might strip away important contextual information, especially time-based relationships that are useful for accurate causal analysis. Additionally, some schemes lack integrated privacy and compliance mechanisms capable of handling sensitive data across multiple regulatory frameworks while maintaining analytical capabilities, forcing organizations to choose between comprehensive analysis and regulatory compliance.

The limitations of these schemes become particularly problematic when analyzing complex scenarios where causes and effects span multiple specialized domains - for example, understanding how financial market anomalies might relate to regulatory changes, supply chain disruptions, and consumer behavior patterns, all while preserving temporal sequence and causal direction. In such cases, some schemes either fail to identify important cross-domain relationships or require extensive manual integration of insights from different analytical components, making timely and comprehensive analysis computationally infeasible.

Some schemes suffer from specific technical deficiencies when processing cross-domain data, including: (1) computational inefficiency in normalizing heterogeneous data while preserving semantic relationships; (2) inability to track dependencies between analyses performed by different specialized modules; (3) failure to converge or requiring manual intervention when refining analyses through iterative processing; and (4) limitations in processing the full scope of available data due to these technical constraints. These deficiencies result in tangible computing problems—excessive processing requirements, incomplete pattern identification, and inaccurate analytical outputs—that the technology disclosed herein specifically addresses through its novel technical architecture and processing methodologies.

The disclosed technology provides, among other things, a novel multi-agent artificial intelligence system that transforms how computers process and analyze complex cross-domain data. At its core, the system implements a hierarchical architecture of specialized transformer neural networks that are specifically trained to process domain-specific data, combined with a master analysis model that coordinates the specialized models through a novel iterative feedback mechanism. The system first processes input data through specialized data extraction and normalization modules that convert heterogeneous data (e.g., scanned documents, structured databases, temporal sequences) into standardized formats, generating both a temporal database that preserves time-based relationships and a hierarchical data structure that explicitly captures primary and secondary indicators and their interdependencies.

The specialized transformer neural networks are trained through an iterative process using domain-specific literature and expert-validated analysis patterns, resulting in models that can effectively process the standardized data structures within their respective domains. Each specialized model processes both primary indicators directly related to conditions of interest and secondary indicators that may have indirect relationships, along with their temporal patterns. This allows the system to identify complex relationships that might be missed by traditional single-domain analysis systems. For example, in a medical context, a cardiology model might identify patterns in heart-related markers while a rheumatology model processes inflammation markers, with both models being able to process temporal relationships and indirect indicators that might signal underlying conditions.

The master analysis model implements a novel feedback loop mechanism that coordinates the specialized models and refines their analyses. Rather than simply combining outputs from different specialized models, the master model identifies interdependencies between different domains' analyses and generates specific feedback for each specialized model. This feedback is used to update the domain-specific analyses, and the process repeats until meeting defined convergence criteria. This iterative refinement process allows the system to automatically discover and validate complex cross-domain relationships and root causes that would be computationally infeasible to identify through traditional methods. The system then generates a comprehensive analysis report that preserves these cross-domain relationships and temporal patterns, structured in a way that makes the complex interdependencies and root causes clear and actionable. This technical approach enables the system to process and analyze vastly larger datasets than previous systems, while automatically identifying complex patterns, relationships, and root causes that span multiple domains. The approach is particularly helpful to address problems such as complex medical root cause analysis, where different domains (e.g. different organs and bodily systems) are deeply interconnected (e.g. by the same blood circulating around the whole body), where the number of data points is very large (e.g. potentially thousands of biomarker levels, genetic variants), and the interdependencies and root causes are hence potentially highly complex.

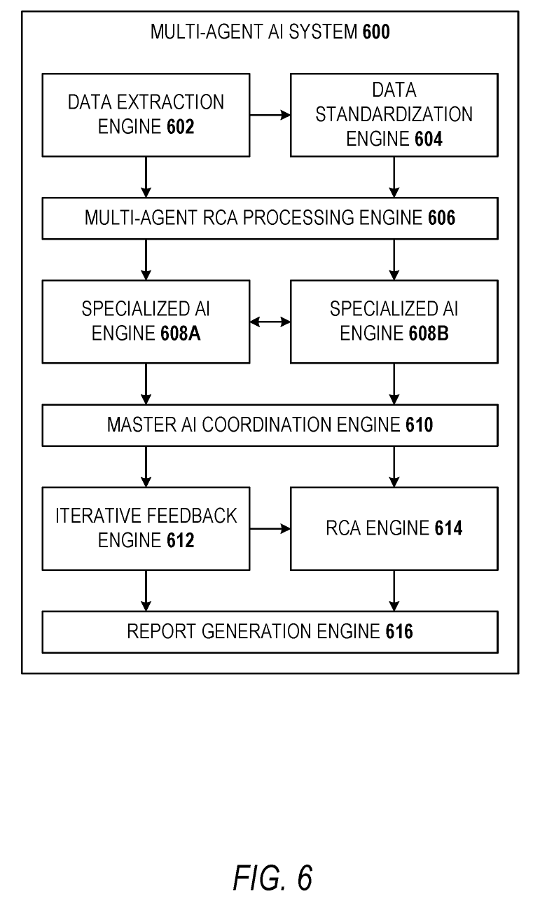

FIG. 6 is a block diagram of a multi-agent AI system 600, in accordance with some embodiments. The multi-agent AI system may be stored in at least one of the main memory 504, the static memory 506, or the drive unit 516, and may incorporate AI technologies, such as those described in conjunction with FIGS. 1-4 or other AI technologies. As shown, the multi-agent AI system 600 includes a data extraction engine 602, a data standardization engine 604, a multi-agent root cause analysis (RCA) processing engine 606, specialized AI engines 608A-B, a master AI coordination engine 610, an interactive feedback engine 612, an RCA engine 614, and a report generation engine 616.

The data extraction engine 602 is configured to ingest data from multiple data sources in different formats, including structured, semi-structured, and/or unstructured data. The data extraction engine 602 may employ optical character recognition (OCR) for document-based sources, natural language processing (NLP) for textual data, and various machine learning-based feature extraction techniques for numerical, categorical, and temporal datasets. This engine serves as the initial point of contact for incoming data that requires analysis.

The data standardization engine 604 receives extracted data from the data extraction engine 602 and normalizes it into standardized formats suitable for cross-domain analysis. This may include, among other things, mapping terminology to domain-specific ontologies, converting measurement units to ensure consistency, and validating extracted values against reference standards. The data standardization engine 604 generates both a temporal database that preserves time-based relationships between data elements and a hierarchical data structure that explicitly captures primary indicators, secondary indicators, and their interdependencies.

The multi-agent RCA processing engine 606 orchestrates the overall analysis process, coordinating between the specialized AI engines 608A-B. This engine implements a hierarchical architecture of specialized transformer neural networks, each trained to process domain-specific data while maintaining awareness of cross-domain dependencies. The RCA processing engine 606 serves as the computational framework within which the specialized AI engines 608A-B operate. While two specialized AI engines 608A-B are illustrated, the disclosed technology may be implemented with other numbers of specialized AI engines.

The specialized AI engines 608A-B are domain-specific artificial intelligence engines configured with specialized data processing models. Each specialized AI engine analyzes specific aspects of the standardized data, processing both primary indicators directly related to conditions of interest and secondary indicators having indirect relationships to these conditions. For example, in a healthcare context, specialized AI engine 608A might focus on cardiology data while specialized AI engine 608B might analyze endocrinology data, with both engines being able to recognize relationships across their respective domains. In another example, in analyzing financial data for an investment business, the specialized AI engines 608A-B may include at least one of a tax engine, a stocks engine, a cryptocurrency engine, a commodities engine, and a precious metals engine.

The master AI coordination engine 610 integrates outputs from the specialized AI engines 608A-B and identifies cross-domain patterns and relationships. This engine analyzes the initial domain-specific analyses, identifies interdependencies and causal relationships between analyses from different specialized AI engines, and coordinates information exchange between them to enable comprehensive cross-domain analysis. The master AI coordination engine 610 ensures that insights developed in one domain can inform and enhance analyses in other domains.

The iterative feedback engine 612 implements a feedback loop that continuously refines analyses based on new insights. This engine generates feedback for each specialized AI engine based on identified interdependencies and cross-domain relationships, helping to update domain-specific analyses until meeting defined convergence criteria. The iterative feedback engine 612 may assign confidence scores to insights generated by each specialized AI engine and adjust processing priorities based on historical accuracy.

The RCA engine 614 implements various root cause analysis methodologies to identify causes of detected anomalies in the data provided by at least one of the master AI coordination engine 610 or the iterative feedback engine 612. These methodologies may include the Five Whys technique, Ishikawa diagram analysis, Issue-Based Information Systems, Issue Tree analysis, Why-Because Graphs, Fault Tree Analysis, Causal Loop Diagrams, Bayesian Networks, and other analytical frameworks. The RCA engine 614 applies these techniques iteratively, tracing causal chains across multiple data sources and domains.

The report generation engine 616 creates customizable reports based on the consolidated findings from the analysis process. These reports can be tailored to different user expertise levels and may include interactive visualizations of the data structure mapping relationships between detected anomalies and their identified causes. The report generation engine 616 ensures that complex cross-domain relationships and temporal patterns are presented in a clear, actionable format.

Together, these components form the multi-agent AI system 600 capable of processing and analyzing complex cross-domain data to identify anomalies and their root causes, providing actionable insights through structured reports. The multi-agent AI system 600 overcomes traditional computational limitations by effectively normalizing heterogeneous data while preserving semantic relationships necessary for cross-domain analysis.

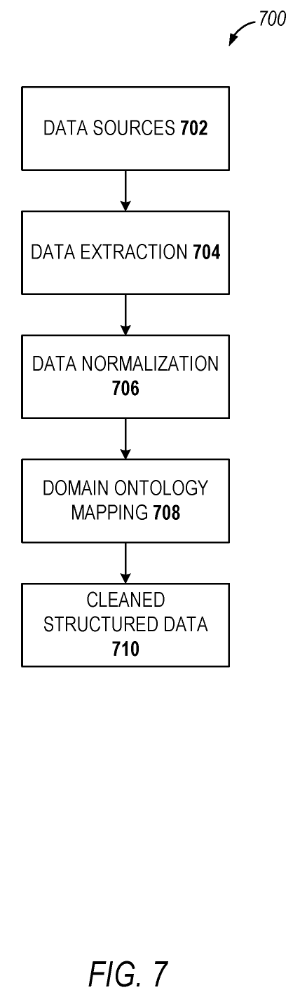

FIG. 7 is a data flow diagram for data extraction and standardization 700, in accordance with some embodiments. As shown, the data extraction and standardization 700 includes accessing data sources 702, applying data extraction 704, applying data normalization 706, and applying data ontology mapping 708 to generate clean structured data 710.

The data sources 702 represent multiple sources of input data in different formats. These sources may include one or more of electronic databases (e.g., SQL databases, NoSQL databases, or cloud repositories), free-text reports, portable document format (PDF) files, scanned documents, streaming data sources such as Internet of Things (IoT) devices, real-time transaction logs, and other structured, semi-structured, or unstructured data repositories. In some examples, a single complex dataset may involve processing over thousands or tens of thousands of data points collected across multiple time periods while maintaining the complex temporal relationships and interdependencies between these data points.

The data extraction 704 involves sophisticated extraction techniques to transform raw data from various sources into a processable format. This may include OCR for document-based sources to convert image-based text into machine-readable text, NLP for analyzing textual content, and machine learning-based feature extraction for numerical, categorical, and temporal datasets. The data extraction 704 may implement specialized extraction algorithms tailored to different data formats to ensure comprehensive information capture while minimizing data loss during the extraction process.

The data normalization 706 converts the extracted heterogeneous data into standardized formats suitable for cross-domain analysis. This process includes normalizing terminology across different conventions, standardizing measurement units to ensure consistent representation across datasets, and handling missing values through appropriate imputation methods. The data normalization 706 also includes temporal alignment of data collected at different time points, ensuring that time-based relationships between data elements are preserved for subsequent analysis. This stage may be useful for enabling comparisons between data points from different sources that may use varying conventions or measurement systems.

The domain ontology mapping 708 maps the normalized data to standardized domain-specific ontologies, ensuring semantic consistency across the dataset. This process involves associating data elements with standardized terminology and relationship structures specific to relevant domains. For example, in healthcare applications, biomarker data might be mapped to standardized medical terminology systems such as LOINC (Logical Observation Identifiers Names and Codes) or SNOMED CT, while financial data might be mapped to standardized financial reporting frameworks such as IFRS (International Financial Reporting Standards). The domain ontology mapping 708 ensures that data from different sources can be meaningfully integrated despite variations in original terminology or classification systems.

The cleaned structured data 710 is the output of the data extraction and standardization 700, representing a unified, standardized dataset ready for analysis by specialized AI engines. This structured data preserves both the semantic content of the original data and the relationships between different data elements, particularly temporal relationships and cross-domain dependencies. The cleaned structured data 710 is organized in a hierarchical data structure that explicitly captures primary indicators (directly associated with conditions of interest), secondary indicators (providing indirect evidence of domain conditions), and the interdependencies between them. This standardized data structure serves as the foundation for all subsequent analysis processes performed by the multi-agent AI system.

The data flow illustrated in FIG. 7 addresses critical technical challenges in processing large volumes of heterogeneous data by providing a systematic approach to extract, normalize, and structure information in a way that preserves semantic relationships that may be useful for comprehensive cross-domain analysis.

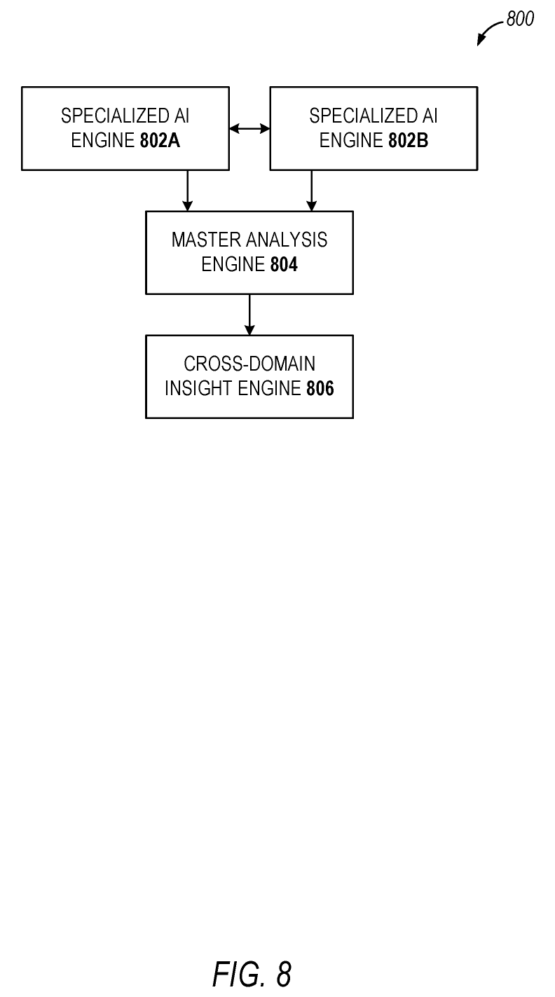

FIG. 8 is a block diagram of an AI system 800, in accordance with some embodiments. As shown, the AI system 800 includes specialized AI engines 802A-B, a master analysis engine 804, and a cross-domain insight engine 806.

The specialized AI engines 802A-B represent domain-specific artificial intelligence models trained to process and analyze data within their respective specialized fields. Each specialized AI engine implements a transformer neural network architecture specifically trained on domain-specific literature and expert-validated analysis patterns. The specialized AI engines 802A-B are configured to process both primary indicators directly related to conditions of interest and secondary indicators that may have indirect relationships, along with their temporal patterns. For example, specialized AI engine 802A might be trained to analyze financial data including market trends, transaction patterns, and regulatory information, while specialized AI engine 802B might focus on healthcare data including biomarkers, patient history, and treatment outcomes. These engines communicate with each other to share insights that may impact analyses across domains.

The master analysis engine 804 serves as the coordinating component that oversees the specialized AI engines 802A-B and synthesizes their outputs into a cohesive analytical framework. Unlike conventional systems that simply aggregate outputs from different analytical modules, the master analysis engine 804 actively identifies interdependencies between the analyses performed by different specialized AI engines and generates specific feedback for each. This feedback mechanism enables the specialized AI engines to refine their analyses based on insights from other domains, creating an iterative improvement process that continues until defined convergence criteria are met. The master analysis engine 804 employs a sophisticated coordination protocol that balances the confidence levels of different domain-specific analyses and prioritizes areas where additional processing would yield the greatest analytical benefits.

The cross-domain insight engine 806 processes the integrated outputs from the master analysis engine 804 to identify patterns, relationships, and causal connections that span multiple domains. This engine implements advanced analytical techniques to detect complex interdependencies that might be missed when analyzing each domain in isolation. The cross-domain insight engine 806 constructs a comprehensive data structure that maps relationships between detected anomalies and their identified causes, indicating the likelihood that specific causes are associated with observed anomalies. These likelihoods are determined using trained machine learning models that evaluate temporal correlations between historical anomalies and verified causes. By identifying cross-domain dependencies, the cross-domain insight engine 808 can reveal how factors in one domain (such as regulatory changes) might influence outcomes in another domain (such as market performance), even when these relationships are not immediately apparent.

Together, these components form the AI system 800 capable of performing sophisticated multi-domain analysis, overcoming the limitations of traditional single-domain analytical approaches. The ability of the AI system 800 to coordinate between the specialized AI engines 802A-B and identify cross-domain patterns enables it to process vastly larger datasets than previous systems while automatically identifying complex relationships and root causes that span multiple domains. This approach is particularly effective for analyzing complex problems where different domains (e.g., different organs and bodily systems in healthcare, or different market sectors in finance) are deeply interconnected and where the number of data points and potential interdependencies is very large.

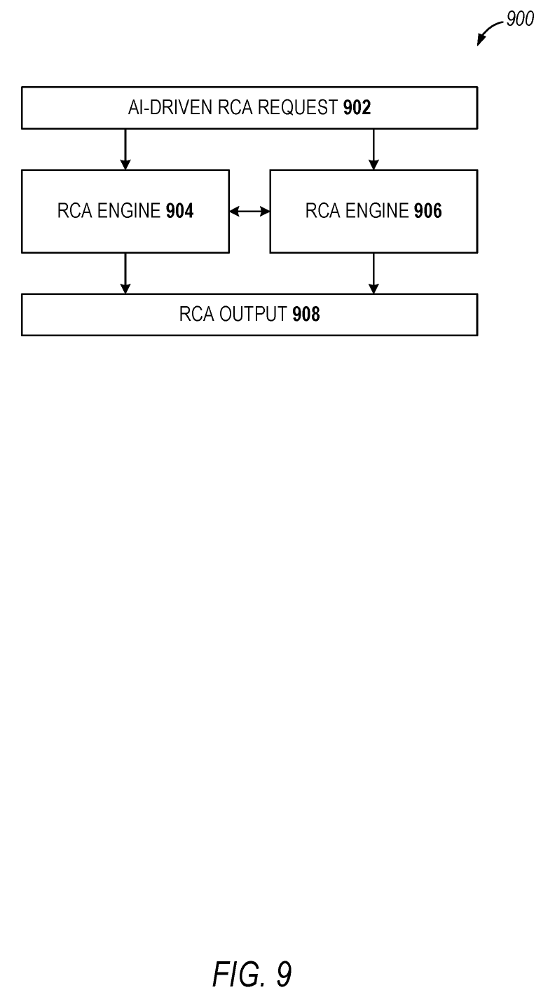

FIG. 9 is a data flow diagram for an RCA workflow 900, in accordance with some embodiments. As shown, an AI-driven RCA request 902 is provided to RCA engines 904 and 906. The RCA engines 904 and 906 communicate with one another to generate the RCA output 908. It should be noted that, while two RCA engines 904 and 906 are illustrated in FIG. 9, the disclosed technology may be implemented with other numbers of RCA engines.

The AI-driven RCA request 902 represents the initiation of a root cause analysis process based on detected anomalies or issues identified in the input data. The detected anomalies or issues may be identified using the techniques described in conjunction with FIGS. 1-8. For example, the multi-agent AI system 600 may detect anomalies through its data extraction engine 602 and data standardization engine 604 by identifying outliers in the cleaned structured data 710, or the specialized AI engines 802A-B of the AI system 800 may flag inconsistencies when processing domain-specific information, or the cross-domain insight engine 806 may detect patterns that deviate from expected relationships across multiple domains. This request may specify parameters such as the type of anomaly detected, the domains involved, temporal constraints for the analysis, and any contextual information that may be relevant for identifying potential causes. The AI-driven RCA request 902 serves as the trigger for the specialized root cause analysis process, directing the system to investigate the underlying causes of specific issues detected during data processing.

The RCA engine 904 implements one or more root cause analysis methodologies to systematically identify and validate potential causes for the detected anomalies. These methodologies may include the Five Whys technique, which recursively questions each detected anomaly to trace systemic failures; Ishikawa (Fishbone) Diagram analysis, which categorizes multifactorial influences contributing to detected anomalies; Issue Tree analysis, which decomposes complex problems into hierarchical components; and Why-Because Graph analysis, which represents causal chains for enhanced interpretability. The RCA engine 904 may also implement more advanced analytical techniques such as Fault Tree Analysis, Causal Loop Diagrams, Bayesian Network analysis, Granger Causality analysis, or other methodologies appropriate for the specific domain and type of anomaly being investigated.

The RCA engine 906, similar to RCA engine 904, implements root cause analysis methodologies but may focus on different aspects of the detected anomalies or utilize different analytical approaches. The use of multiple RCA engines enables the system to approach the problem from different analytical perspectives, increasing the likelihood of identifying the true root causes. The RCA engines 904 and 906 communicate with each other during the analysis process, sharing insights and intermediate results to refine their respective analyses. This bidirectional communication allows for cross-validation of potential causes and ensures that the analysis benefits from the strengths of each RCA methodology.

The RCA output 908 represents the consolidated findings from the root cause analysis process. This output includes a data structure mapping relationships between the detected anomalies and their identified causes, with each relationship associated with a likelihood score determined using trained machine learning models. The data structure indicates the probability that specific identified causes are associated with the observed anomalies, based on temporal correlations between historical anomalies and verified causes. The RCA output 908 may also include a directed graph representation where nodes represent anomalies and causes, and edges represent causal relationships with associated likelihood scores. This comprehensive output enables users to understand not only what the root causes are but also the strength of evidence supporting each causal relationship and the complex interdependencies between multiple causes and effects.

The workflow illustrated in FIG. 9 enables the system to perform sophisticated root cause analysis across multiple domains, tracing causal chains that may span different specialized fields and identifying complex relationships that would be difficult or impossible to detect using traditional single-domain analysis approaches. This capability is particularly valuable for addressing problems such as complex medical diagnostics, financial market anomalies, or industrial system failures where causes and effects may be distributed across multiple interconnected systems or processes.

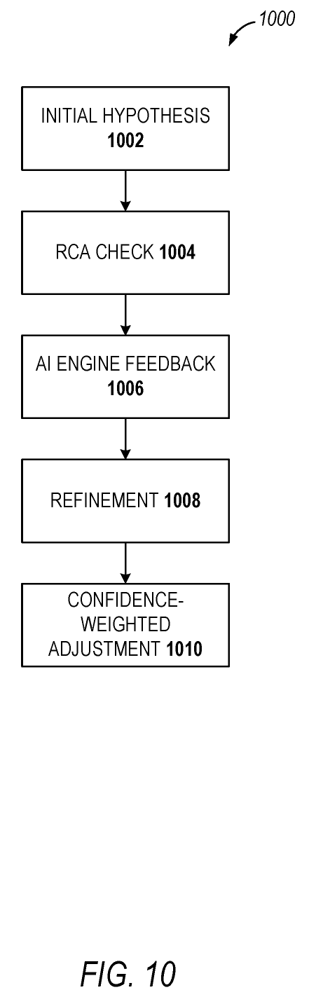

FIG. 10 is a data flow diagram of an iterative feedback technique 1000, in accordance with some embodiments. As shown, an initial hypothesis 1002 is received. An RCA check 1004 is performed on the initial hypothesis, resulting in AI engine feedback 1006. Refinement 1008 of the AI engine feedback 1006 is performed, resulting in a confidence-weighted adjustment 1010 of the AI engine feedback 1006.

The initial hypothesis 1002 represents the preliminary assessment generated by one or more specialized AI engines regarding potential causes for detected anomalies. This hypothesis serves as the starting point for the iterative refinement process and may include multiple potential explanations for observed issues, each associated with an initial confidence score. The initial hypothesis 1002 is formulated based on domain-specific knowledge and preliminary analysis of the standardized data, but it may not yet account for cross-domain dependencies or complex causal relationships that span multiple specialized fields.

The RCA check 1004 subjects the initial hypothesis to rigorous verification through various root cause analysis methodologies. This process evaluates the plausibility of the proposed causal relationships by examining supporting evidence, testing alternative explanations, and validating the logical consistency of the hypothesis. The RCA check 1004 may implement multiple analytical techniques simultaneously, such as Why-Because Graphs to visualize causal chains, Ishikawa Diagrams to map multifactorial influences, or Bayesian Network analysis to model probabilistic relationships between variables. This comprehensive evaluation identifies strengths and weaknesses in the initial hypothesis and generates specific feedback points for refinement.

The AI engine feedback 1006 comprises structured input from other specialized AI engines (e.g., the specialized AI engines 802A-B) and/or the master analysis model (e.g., the master analysis engine 804) regarding the initial hypothesis. This feedback identifies potential gaps, inconsistencies, or alternative explanations that should be considered in refining the analysis. For example, a healthcare investment-focused AI engine might provide feedback on a financial analysis by highlighting how patient demographic trends could influence observed market patterns. The AI engine feedback 1006 is itself a sophisticated analytical product, as each contributing AI engine evaluates the initial hypothesis from its own domain-specific perspective while accounting for potential cross-domain effects.

The refinement 1008 process incorporates the AI engine feedback to improve the initial hypothesis. The refinement 1008 involves adjusting causal relationships, adding previously unidentified factors, removing unsupported connections, or modifying the strength of proposed associations based on the collective intelligence of the multi-agent system. The refinement process may involve multiple iterations, with each cycle incorporating new insights and gradually converging toward a more accurate and comprehensive explanation of the observed anomalies. This iterative approach enables the system to progressively build a more nuanced understanding of complex causal relationships, particularly those that span multiple domains.

The confidence-weighted adjustment 1010 is the output of the feedback cycle, where the refined hypothesis is assigned updated confidence scores based on the collective assessment of all specialized AI engines. These scores reflect the system's degree of certainty regarding each proposed causal relationship, weighted according to the historical accuracy and reliability of each contributing AI engine in similar analytical contexts. The confidence-weighted adjustment 1010 ensures that the most reliable insights are given greater influence in subsequent analytical iterations, effectively implementing an AI process where the system improves its analytical performance based on past results. This adjusted hypothesis then becomes the starting point for the next iteration of the feedback loop, or if convergence criteria are met, forms the basis for the final root cause analysis output.

The iterative feedback technique 1000 represents a significant advancement over traditional analytical approaches by enabling dynamic refinement of complex causal analyses through structured collaboration between specialized AI engines. This technique allows the system to progressively build a comprehensive understanding of intricate cause-and-effect relationships that span multiple domains, ultimately producing analyses that are both more accurate and more comprehensive than would be possible with conventional single-iteration approaches.

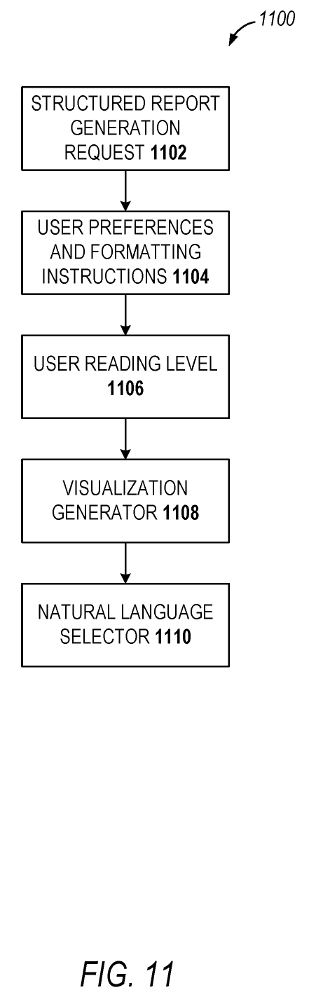

FIG. 11 is a data flow diagram of a structured report generation technique 1100, in accordance with some embodiments. As shown, a structured report generation request 1102 is received. The structured report generation request 1102 is adjusted based on user preferences and formatting instructions 1104 and a user reading level 1106. The user preferences and formatting instructions 1104 may be provided by the user, for example, via a graphical user interface. The user reading level 1106 may be specified by the user, for example, via the graphical user interface, or may be determined based on stored information (e.g., at least one of an education level, a profession, or a status (e.g., doctor or patient)) of the user. A visualization generator 1108 generates a visualization of the report, and a natural language selector 1110 allows the user to select the natural language (e.g., English, French or Japanese) in which the report is to be generated.

The structured report generation request 1102 initiates the process of creating a comprehensive report based on the findings from the multi-agent AI system's analysis. This request may be triggered automatically upon completion of the root cause analysis process or initiated manually by a user seeking insights into specific anomalies or issues. The structured report generation request 1102 includes parameters such as the scope of the report, the specific analyses to be included, the desired level of detail, and any particular focus areas of interest. This initial request serves as the foundation for a customized report tailored to the specific needs and preferences of the intended recipient.

The user preferences and formatting instructions 1104 represent a set of customization parameters that allow the report to be tailored to specific user requirements. These preferences may include the desired report structure (e.g., executive summary followed by detailed analysis, or problem-solution format), the inclusion of specific types of visualizations (e.g., causal diagrams, temporal trends, or comparative analyses), emphasis on particular domains or aspects of the analysis, and formatting specifications such as the inclusion of tables, charts, or narrative explanations. The system accommodates these preferences to generate a report that aligns with the user's expectations and facilitates effective communication of complex analytical findings.

The user reading level 1106 determines the technical complexity and terminology used in the generated report. This parameter ensures that the report is accessible and valuable to its intended audience, whether they are domain experts requiring technical precision or non-specialists needing clear explanations without field-specific jargon. For example, a report generated for a medical specialist might include detailed biomarker analyses and technical medical terminology, while a report on the same data for a patient might use simplified explanations and focus on practical implications. The system may dynamically adjust terminology, explanation depth, and supporting context based on this reading level parameter, ensuring optimal communication effectiveness.

The visualization generator 1108 creates interactive visual representations of the analytical findings to enhance understanding and insight discovery. These visualizations may include causal chain diagrams showing relationships between identified causes and effects, temporal pattern graphs illustrating how variables change over time, heatmaps highlighting correlation strengths between different factors, and interactive decision trees allowing users to explore different analytical paths. The visualization generator 1108 implements sophisticated data visualization techniques that transform complex multi-dimensional data and causal relationships into intuitive visual formats, making it easier for users to grasp complex interdependencies and identify key insights from the analysis.

The natural language selector 1110 enables the generation of reports in multiple languages, enhancing accessibility for global users. This component leverages advanced natural language processing and translation capabilities to ensure that the technical content, causal relationships, and analytical insights are accurately conveyed in the selected language while maintaining the correct domain-specific terminology. Beyond simple translation, the natural language selector 1110 adapts the report's structure and explanatory approach to align with linguistic and cultural expectations of the target language, ensuring that complex analytical concepts are communicated effectively regardless of the language selected.

Together, these components form a sophisticated report generation system that transforms complex analytical outputs from the multi-agent AI system into clear, accessible, and actionable reports tailored to the specific needs, preferences, and expertise level of the intended audience. This approach ensures that the valuable insights generated by the system's cross-domain analysis capabilities are effectively communicated to support informed decision-making across various application domains.

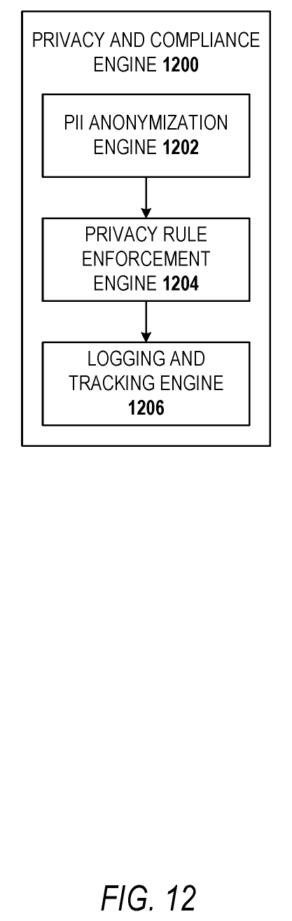

FIG. 12 is a block diagram of a privacy and compliance engine 1200, in accordance with some embodiments. As shown, the privacy and compliance engine 1200 includes a personally identifiable information (PII) anonymization engine 1202, a privacy rule enforcement engine 1204, and a logging and tracking engine 1206.

The PII anonymization engine 1202 is designed to automatically identify and protect sensitive personal information within the input data processed by a multi-agent AI system (e.g., the multi-agent AI system 600). The PII anonymization engine 1202 employs pattern recognition and contextual analysis techniques to detect various categories of personally identifiable information across structured and unstructured data formats. Upon identification, the PII anonymization engine 1202 applies appropriate data transformation techniques such as tokenization, hashing, generalization, perturbation, or synthetic data generation to remove or obscure the sensitive information while preserving the analytical utility of the data. For example, in healthcare applications, the engine may replace specific patient names with anonymous identifiers while maintaining the relationships between patient records and clinical outcomes. This ensures that subsequent analysis can proceed without compromising individual privacy, even when processing sensitive information across multiple domains.

The privacy rule enforcement engine 1204 implements and enforces compliance with privacy rules provided to the privacy and compliance engine 1200. For example, the privacy rules may correspond to or be based on various regulatory frameworks and privacy standards applicable to the data being processed. The privacy rule enforcement engine 1204 may maintain a comprehensive rule base covering requirements from regulations such as the Health Insurance Portability and Accountability Act (HIPAA) for healthcare data, the General Data Protection Regulation (GDPR) for personal data, the Payment Card Industry Data Security Standard (PCI-DSS) for financial transaction security, and/or other industry-specific or regional privacy regulations. The privacy rule enforcement engine 1204 continuously monitors data processing operations within the multi-agent AI system, validating that each operation complies with the applicable privacy rules. If a potential compliance issue is detected, the privacy rule enforcement engine 1204 can automatically apply corrective measures, restrict certain processing operations, or alert system administrators to ensure regulatory compliance throughout the analysis workflow.

The logging and tracking engine 1206 maintains a comprehensive, tamper-evident record of all data processing activities performed by the multi-agent AI system. The logging and tracking engine 1206 creates audit logs that document what data was accessed, what processing was performed, which AI agents were involved, what transformations were applied, and what outputs were generated. These logs are structured to support regulatory compliance verification (e.g., based on rules stored by the privacy rule enforcement engine 1204) and to demonstrate adherence to privacy principles such as data minimization, purpose limitation, and processing transparency. The logging and tracking engine 1206 implements secure logging techniques with cryptographic verification to ensure the integrity and non-repudiation of the audit trail. This comprehensive record-keeping enables organizations to demonstrate compliance during audits, respond effectively to data subject access requests, and maintain accountability for all AI-driven data processing activities.

Together, these components form a privacy and compliance framework that enables the multi-agent AI system to process sensitive data across multiple domains while maintaining strict adherence to privacy regulations and ethical data handling practices. This integrated approach to privacy and compliance is useful for deploying sophisticated AI analysis capabilities in regulated industries such as healthcare, finance, and legal services, where data protection requirements are particularly stringent. The privacy and compliance engine 1200 ensures that the insights generated by the system are obtained through responsible data processing practices, complying with regulations and/or industry best practices.

In some examples, the privacy and compliance engine 1200 implements a privacy-first AI governance approach that ensures regulatory adherence while maintaining analytical capabilities. Beyond the core components described above, the privacy and compliance engine 1200 may enforce real-time data anonymization and compliance verification for various regulatory frameworks such as the HIPAA for healthcare data, the GDPR for personal data privacy, the PCI-DSS for financial transaction security, and other industry-specific or regional privacy regulations. This comprehensive privacy and compliance framework enables the deployment of sophisticated AI analysis capabilities in highly regulated industries. For data subject access requests, the logging and tracking engine 1206 can identify all processing operations performed on specific data subjects, providing complete accountability and transparency. The privacy rule enforcement engine 1204 can also implement specialized security protocols for particularly sensitive domains, such as applying additional layers of protection for genetic data in healthcare applications or implementing enhanced security for financial transaction data.

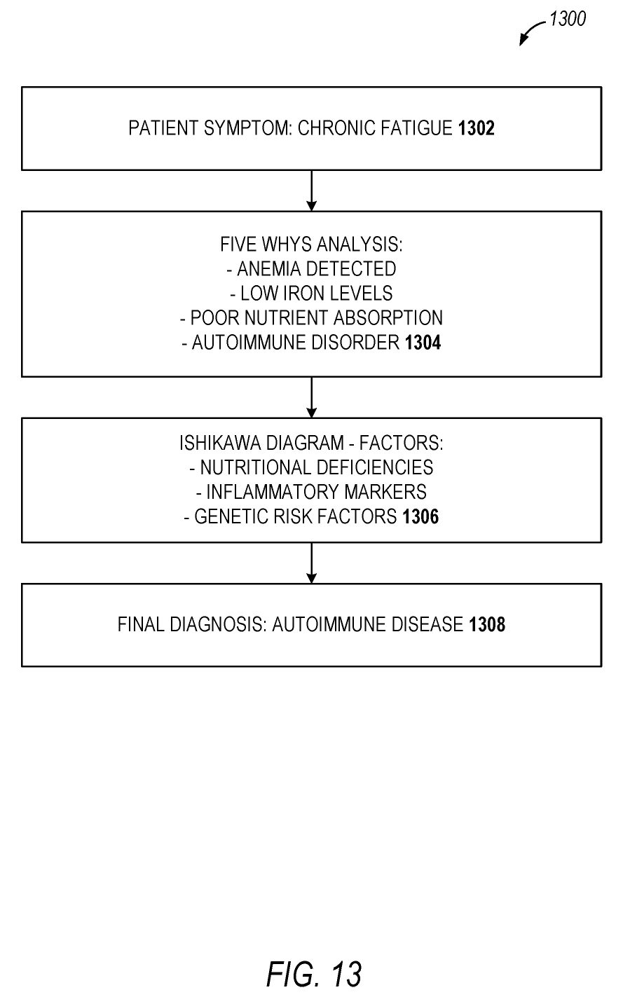

FIG. 13 is a data flow diagram of a healthcare root cause analysis example 1300, in accordance with some embodiments. The input includes a patient symptom 1302 (“chronic fatigue”) and a set of health records of the patient. As shown, the system (e.g., the multi-agent AI system 600) applies five whys analysis 1304 to determine “anemia detected,” “low iron levels,” “poor nutrient absorption,” and “autoimmune disorder” for the patient. The system applies Ishikawa diagram – factors 1306 to identify “nutritional deficiencies,” “inflammatory markers,” and “genetic risk factors” for the patient. Based on the five whys analysis 1304 and the Ishikawa diagram – factors 1306, the system makes a final diagnosis 1308 of “autoimmune disease” for the patient.

The patient symptom 1302 represents the initial presentation that triggers the root cause analysis process within the healthcare context. In this example, "chronic fatigue" serves as the primary complaint, but the system analyzes this symptom not as an isolated issue but as a potential indicator of underlying health conditions. The system ingests and processes the patient's comprehensive health records, including, for example, laboratory test results collected over time, genetic testing data, previous diagnoses, medication history, and lifestyle factors. This holistic approach allows the system to consider a much broader range of potential causal factors than might be feasible in a traditional clinical analysis limited by time constraints and specialization boundaries.

The five whys analysis 1304 represents the implementation of a systematic root cause analysis methodology that repeatedly questions each identified issue to trace back to its fundamental cause. In this example, the analysis begins with the presenting symptom of chronic fatigue and iteratively identifies deeper causes: first detecting anemia (low hemoglobin), then identifying low iron levels as the cause of the anemia, then recognizing poor nutrient absorption as the cause of iron deficiency, and finally identifying an autoimmune disorder as the likely root cause affecting nutrient absorption. This structured approach allows the system to move beyond treating symptoms (such as simply addressing the anemia) to identify the fundamental underlying condition that requires treatment.

The Ishikawa diagram – factors 1306 implements a complementary analytical approach that identifies multiple contributing factors potentially influencing the identified condition. By organizing these factors into categories such as nutritional deficiencies (e.g., specific vitamin and mineral levels), inflammatory markers (e.g., C-reactive protein, erythrocyte sedimentation rate), and genetic risk factors (e.g., specific HLA gene variants associated with autoimmune conditions), the system creates a comprehensive view of the interrelated factors contributing to the patient's condition. This multifactorial analysis is particularly valuable in complex medical cases where conditions may have multiple contributing causes rather than a single clear etiology.

The final diagnosis 1308 represents the culmination of the root cause analysis process, synthesizing insights from both the sequential five whys analysis and the multifactorial Ishikawa diagram analysis to reach a diagnosis of "autoimmune disease." In accordance with some implementations, this diagnosis is not merely a categorization but includes specific supporting evidence, confidence levels, and relationships to observed symptoms and test results. The system can generate a comprehensive diagnostic report that explains how the autoimmune condition is causally linked to the poor nutrient absorption, how this leads to iron deficiency and anemia, and ultimately how these factors collectively contribute to the patient's chronic fatigue. This level of explanatory depth enables healthcare providers to understand not just what condition the patient has, but the specific causal pathways relevant to their individual case.

This healthcare example demonstrates how the multi-agent AI system 600 employs root cause analysis methodologies to process complex medical data spanning multiple physiological systems, laboratory parameters, and temporal patterns. By identifying connections between seemingly disparate health indicators and tracing causal chains across specialized medical domains (such as hematology, gastroenterology, immunology, and genetics), the system can provide insights that might otherwise require consultation with multiple medical specialists. This approach helps address a common challenge in healthcare where complex conditions with manifestations across multiple bodily systems may be difficult to diagnose and treat effectively when analyzed through the lens of a single medical specialty.

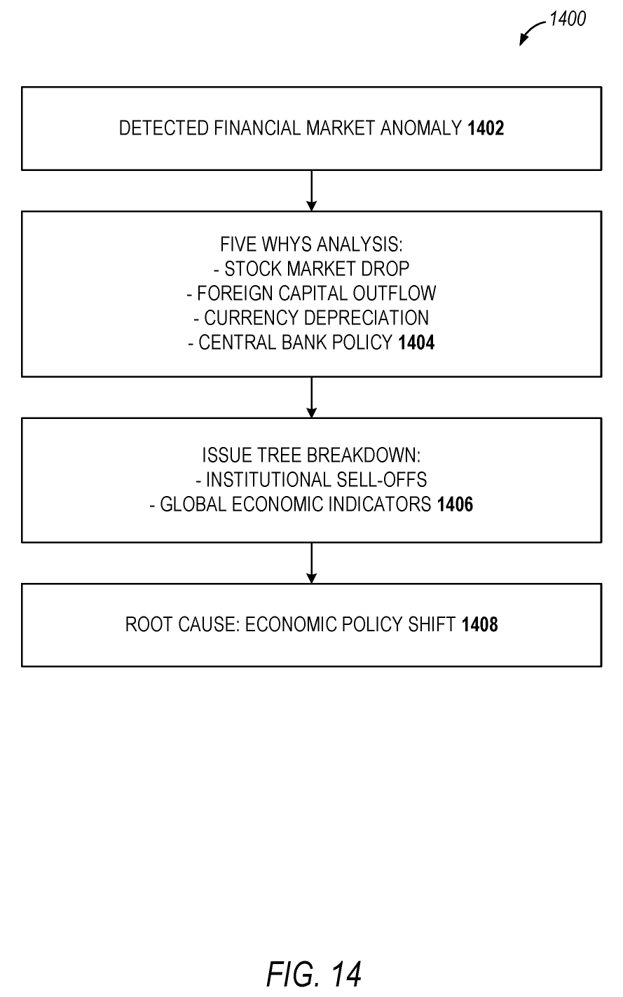

FIG. 14 is a data flow diagram of a financial root cause analysis example 1400, in accordance with some embodiments. As shown, the system (e.g., the multi-agent AI system 600) receives an input of a detected financial market anomaly 1402 along with associated financial data. The system applies five whys analysis 1404 to trace the causal chain from "stock market drop" to "foreign capital outflow" to "currency depreciation" to "central bank policy." The system implements issue tree breakdown 1406 to analyze "institutional sell-offs" and "global economic indicators" as contributing factors. Based on the five whys analysis 1404 and the issue tree breakdown 1406, the system identifies the root cause 1408 as an "economic policy shift."

The detected financial market anomaly 1402 represents the initial observation that triggers the root cause analysis process within the financial context. This anomaly might manifest as unexpected price movements, unusual trading volumes, atypical correlation patterns between assets, or other market behaviors that deviate from historical norms or forecasted expectations. The system ingests comprehensive financial data including market prices, trading volumes, economic indicators, regulatory announcements, news events, and other relevant information across multiple timeframes. This holistic approach allows the system to consider both market-specific factors and broader economic conditions that might influence financial outcomes.

The five whys analysis 1404 implements a structured analytical methodology to trace the causal chain from the observed market anomaly to its fundamental drivers. In this example, the analysis begins with the observed stock market drop and systematically identifies deeper causes: first recognizing foreign capital outflow as a direct contributor to the market decline, then identifying currency depreciation as the factor driving this capital flight, and finally determining that central bank policy changes were the underlying cause of the currency devaluation. This sequential analysis helps financial analysts understand not just what happened in the markets, but why it happened, enabling more informed decision-making about potential future market developments.

The issue tree breakdown 1406 provides a complementary analytical perspective by decomposing the problem into structured components that can be analyzed individually. By examining institutional sell-offs (including, in some cases, detailed analysis of which types of institutions were selling, in what volumes, and with what timing patterns) and global economic indicators (such as interest rate differentials, inflation rates, trade balances, and growth forecasts), the system builds a comprehensive picture of the factors contributing to the observed market anomaly. This structured decomposition allows for detailed analysis of each component while maintaining awareness of their interconnections and relative importance to the overall situation.

The root cause 1408 represents the synthesis of these analyses, identifying an "economic policy shift" as the fundamental driver behind the observed market anomaly. This determination includes specific details about which policies changed, how they deviated from market expectations, and the mechanisms through which they impacted currency values, capital flows, and ultimately stock prices. The system can generate detailed reports explaining these causal relationships, potentially including quantitative models of how similar policy changes have historically affected markets and projections of how current market conditions might evolve as the policy implications continue to unfold.

This financial example demonstrates the multi-agent AI system’s ability to analyze complex market dynamics where outcomes are influenced by interconnected factors spanning multiple domains including monetary policy, international capital flows, institutional investor behavior, and global economic conditions. By identifying causal relationships that cross traditional analytical boundaries between macroeconomics, market microstructure, and institutional investment behavior, the system can provide insights that might not be apparent when analyzing each domain in isolation. This capability is particularly valuable in financial contexts where understanding the root causes of market anomalies can inform risk management strategies, investment decisions, and regulatory responses.

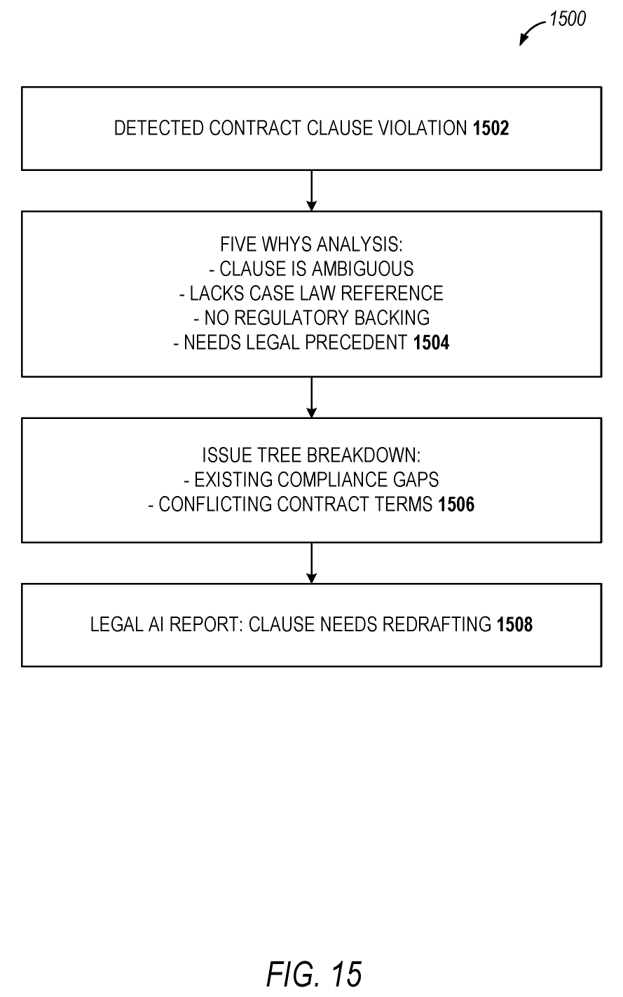

FIG. 15 is a data flow diagram of a legal root cause analysis example 1500, in accordance with some embodiments. As shown, the system (e.g., the multi-agent AI system 600) processes a detected contract clause violation 1502 along with associated legal documents. The system applies five whys analysis 1504 to trace the causal chain from "clause is ambiguous" to "lacks case law reference" to "no regulatory backing" to "needs legal precedent." The system implements an issue tree breakdown 1506 to analyze "existing compliance gaps" and "conflicting contract terms" as contributing factors. Based on the five whys analysis 1504 and the issue tree breakdown 1506, the system generates a legal AI report 1508 concluding that the "clause needs redrafting."

The detected contract clause violation 1502 represents the initial issue that triggers the root cause analysis process within the legal context. This detection might occur during contract review, compliance auditing, or when a dispute arises regarding contract interpretation. The system ingests comprehensive legal documentation including the full contract text, related agreements, applicable regulations, relevant case law, and historical contract performance data. This thorough approach enables the system to analyze the contract clause not in isolation but within its complete legal, regulatory, and business context.

The five whys analysis 1504 implements a systematic analytical methodology to trace the root causes of the contract clause violation. In this example, the analysis begins with identifying that the clause is ambiguous, then determines this ambiguity stems from a lack of reference to applicable case law, which in turn results from an absence of clear regulatory backing, ultimately revealing that the clause requires legal precedent to properly establish its meaning and enforceability. This sequential analysis helps legal professionals understand not just that the clause is problematic, but precisely why it fails to achieve its intended legal purpose, enabling targeted remediation efforts.

The issue tree breakdown 1506 provides a structured decomposition of the problem into distinct components that can be analyzed individually and in relation to each other. By examining existing compliance gaps (which might include specific regulatory requirements not adequately addressed in the contract) and conflicting contract terms (where different sections of the contract contain provisions that create internal inconsistencies), the system builds a comprehensive understanding of the interrelated factors contributing to the contract clause violation. This methodical breakdown allows legal teams to address each problematic aspect while maintaining awareness of its interconnections with other contract elements.

The legal AI report 1508 represents the culmination of these analyses, concluding that the clause needs redrafting to address the identified issues. This report includes specific recommendations for how the clause should be modified, references to relevant legal precedents that should be incorporated, guidance on resolving the identified compliance gaps, and suggestions for harmonizing conflicting terms within the contract. The report may also assess potential legal risks associated with the current clause and quantify the risk reduction expected from implementing the recommended changes, providing valuable decision support for legal teams and business stakeholders.

This legal example demonstrates the multi-agent AI system's capability to analyze complex legal documents where issues may arise from subtle interactions between contract language, regulatory requirements, case law interpretations, and business practices. By identifying causal relationships that span contract drafting, regulatory compliance, and legal precedent, the system can provide insights that might not be apparent when reviewing documents through a single legal lens. This approach may be valuable in complex regulatory environments where contracts are to satisfy multiple evolving compliance requirements while remaining practically enforceable and aligned with business objectives.

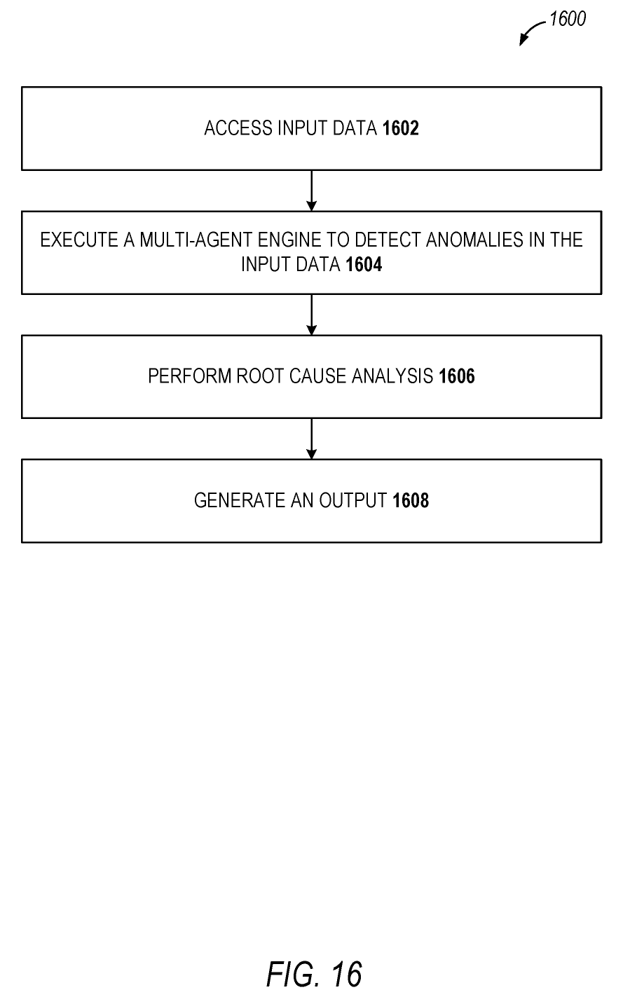

FIG. 16 is a flow chart of a multi-agent artificial intelligence technique 1600 for processing cross-domain data, in accordance with some embodiments. The technique 1600 may be performed by a computer (or multiple computers) including processing circuitry and a memory subsystem. For example, the technique 1600 may be performed using the multi-agent AI system 600.

At 1602, the computer accesses input data from multiple data sources in different formats. These data sources may include structured, semi-structured, and unstructured data such as electronic databases (e.g., SQL databases, NoSQL databases, or cloud repositories), free-text reports, PDF files, scanned documents, streaming data sources including IoT devices, real-time transaction logs, and other data repositories. The input data may include complex datasets involving thousands or tens of thousands of data points collected across multiple time periods while preserving the temporal relationships and interdependencies between data points. The plurality of agents may be implemented as a hierarchical architecture of specialized transformer neural networks, where each transformer neural network is trained to process domain-specific data. The master analysis engine integrates outputs from the specialized transformer neural networks to identify cross-domain patterns and relationships.

At 1604, the computer executes a multi-agent engine to detect anomalies in the input data. The computer deploys a plurality of agents (e.g., the specialized AI engines 608A-B) configured with specialized data processing models, where each agent analyzes an aspect of the input data. The computer coordinates, via a master analysis engine (e.g., the master AI coordination engine 610), information exchange between the plurality of agents to standardize the input data into a normalized format to enable cross-domain analysis.

In some examples, standardizing the input data into a normalized format includes converting heterogeneous data into standardized formats, generating a temporal database that preserves time-based relationships between data elements, and creating a hierarchical data structure that explicitly captures primary indicators, secondary indicators, and interdependencies between the primary indicators and the secondary indicators across the multiple data sources. This process may include normalizing terminology across different conventions, standardizing measurement units to ensure consistent representation, and handling missing values using artificial intelligence or statistical imputation techniques. The process may further include mapping the normalized data to standardized domain-specific ontologies, ensuring semantic consistency across the dataset.

In some examples, the hierarchical data structure created during data standardization incorporates both temporal relationships and cross-domain interdependencies. For primary indicators directly related to conditions of interest, the system explicitly represents their direct relationships to those conditions. For secondary indicators that provide indirect evidence of domain conditions, the computer maps their connections to primary indicators and maintains these relationships in the structured data format. This comprehensive mapping of interdependencies enables more sophisticated analysis that can reveal how seemingly disparate indicators from different domains may collectively contribute to observed anomalies. For example, in healthcare applications, this might involve connecting inflammatory markers (secondary indicators) to specific disease manifestations (primary indicators) across multiple physiological systems, preserving the relationships needed for comprehensive cross-domain analysis.

In some examples, each agent of the plurality of agents processes both primary indicators directly related to conditions of interest and secondary indicators having indirect relationships to the conditions of interest. The computer identifies relationships across multiple domains associated with at least a subset of the plurality of agents. This enables the computer to identify complex relationships that might be missed by traditional single-domain analysis systems.

The specialized data processing models used by the plurality of agents include transformer neural networks trained through an iterative process using training data comprising domain-specific literature and expert-validated analysis patterns. This training process enables the models to effectively process the standardized data structures within their respective domains.

At 1606, the computer performs root cause analysis. The computer applies an iterative processing technique to identify causes of the detected anomalies in the input data. The iterative processing technique includes recursively analyzing detected anomalies to trace causal chains across the multiple data sources. The computer generates a data structure mapping relationships between the detected anomalies and the identified causes. The data structure indicates a likelihood that at least one identified cause is associated with at least one detected anomaly. The likelihood is determined using a trained machine learning model that evaluates temporal correlations between historical anomalies and verified causes. The data structure reduces processing requirements for subsequent anomaly detection operations.

Performing the root cause analysis may further include identifying interdependencies between analyses by at least a subset of the plurality of agents, generating additional data for at least one agent of the plurality of agents based on the identified interdependencies, and updating, by the at least one agent, a domain-specific analysis based on the additional data until meeting a convergence criterion. This iterative feedback mechanism enables each specialized agent to refine their analyses based on insights from other domains, creating an iterative improvement process that continues until defined convergence criteria are met.

In some examples, the data structure mapping relationships includes cross-domain dependencies, where the cross-domain dependencies indicate a relationship between a first anomaly in a first domain and a factor in a second domain different from the first domain. For example, in a healthcare context, this might involve identifying how cardiac symptoms (first domain) relate to inflammatory markers (second domain), or in financial analysis, how regulatory changes (first domain) influence market performance (second domain).

In some examples, the iterative processing technique employed by the computer may comprise at least one of: a Five Whys analysis that recursively questions each detected anomaly; an Ishikawa diagram analysis that categorizes multifactorial influences contributing to detected anomalies; an Issue-Based Information System that structures agent discussions for systematic hypothesis refinement; an Issue Tree analysis that decomposes complex problems into hierarchical components; a Why-Because Graph that represents the causal chains for enhanced interpretability; a Fault Tree Analysis that identifies combinations of faults leading to system failures; a Causal Loop Diagram analysis that identifies feedback relationships between variables; a Bayesian Network analysis that models probabilistic relationships between variables; an Event Chain Methodology that analyzes sequences of events and their relationships; a Failure Mode and Effects Analysis that identifies potential failures and consequences; a Granger Causality analysis that determines whether one time series is useful in forecasting another; an Eight Disciplines (8D) problem-solving methodology that systematically identifies root causes and corrective actions; or a Factor Analysis that identifies underlying factors influencing observed variables.

For example, implementing a Five Whys analysis within the multi-agent engine involves programmatically generating a sequence of causal inquiries for each detected anomaly. The computer recursively applies natural language processing and logical reasoning to formulate increasingly deeper questions, with each response serving as the basis for the subsequent query. This implementation stores the complete causal chain as a directed acyclic graph, with each node representing a cause level and weighted edges indicating confidence in the causal relationship. The Five Whys analysis continues until reaching a root cause that cannot be further decomposed or until reaching a predetermined depth limit based on domain-specific heuristics.

When implementing Ishikawa diagram analysis, the computer classifies potential causal factors into standardized categories such as machine, method, material, measurement, environment, and human factors (in manufacturing contexts) or adapted categories appropriate for the specific domain (e.g., physiological, pharmacological, genetic, and environmental factors in healthcare). The specialized agents identify candidate causes within their domains and assign confidence scores to each cause. The master analysis engine then aggregates these causes into a comprehensive data structure that preserves the hierarchical categorization while quantifying the relative contribution of each factor to the detected anomaly.

Implementation of Issue-Based Information System (IBIS) analysis involves structuring the dialogue between specialized agents as a formal argumentation framework. The computer represents issues, positions, and arguments as distinct nodes in a decision tree, with machine learning algorithms evaluating the strength of supporting evidence for each argument. As specialized agents contribute domain-specific insights, the system incrementally constructs a comprehensive map of possible explanations, objections, and supporting evidence. This implementation enables systematic hypothesis refinement through structured agent interactions and explicitly models the logical relationships between competing explanations.

For Why-Because Graph analysis implementation, the computer constructs a directed graph where nodes represent events, conditions, or states, and edges represent verified causal relationships. The graph construction algorithm enforces formal causality rules, such as ensuring that causes must precede effects temporally and that causal chains must be logically consistent. The implementation employs specialized verification routines that identify and eliminate cycles, validate temporal consistency, and check for logical contradictions. The resulting graph provides a formal representation of the causal chains leading to detected anomalies, with quantified confidence metrics associated with each causal link.

When implementing Bayesian Network analysis, the computer constructs a probabilistic graphical model representing random variables as nodes and conditional dependencies as directed edges. The implementation includes parameter learning algorithms that estimate conditional probability distributions from historical data and structural learning algorithms that discover the network topology. Inference algorithms such as variable elimination or Markov Chain Monte Carlo methods compute posterior probabilities to quantify the likelihood of potential causes given observed anomalies. This implementation enables the system to reason under uncertainty and combine evidence from multiple sources while accounting for complex probabilistic dependencies between variables.

In some examples, coordinating the information exchange between the plurality of agents includes assigning confidence scores to insights generated by each agent, weighting the insights based on the assigned confidence scores, and adjusting agent processing priorities based on historical accuracy of insights from each agent. This approach ensures that the most reliable insights are given greater influence in subsequent analytical iterations, effectively implementing a process where the system improves its analytical performance based on past results.

In some examples, the data structure mapping relationships between the detected anomalies and the identified cause comprises a directed graph having nodes representing the detected anomalies and the at least one identified cause, and edges representing causal relationships between the nodes. Each edge is associated with the likelihood determined by the trained machine learning model. This directed graph representation enables users to understand not only what the root causes are but also the strength of evidence supporting each causal relationship and the complex interdependencies between multiple causes and effects.

In some examples, the computer tracks temporal dependencies by establishing time-sequenced event correlations across the multiple data sources and incorporates the temporal dependencies into the data structure to reflect cause-effect relationships that occur over different time periods. This temporal analysis ensures that time-based relationships between data elements are preserved for subsequent analysis, which is useful for analyzing complex problems where causes and effects may be separated by significant time intervals.

At 1608, the computer generates an output indicating root causes identified through the root cause analysis. The output includes a real-time alert when the likelihood exceeds a threshold. In some examples, the computer customizes the output based on recipient expertise level, generates visualizations of the data structure mapping relationships between the detected anomalies and the identified causes, and provides interactive controls enabling drill-down exploration of the causal chains. This ensures that the insights generated by the system are effectively communicated to support informed decision-making across various application domains.

In an example manufacturing implementation, the multi-agent system monitors a continuous tire manufacturing process by analyzing real-time sensor data from vulcanization equipment, material composition analyzers, and production line systems. When the multi-agent system detects an anomaly in tire sidewall integrity and determines through root cause analysis that the vulcanization temperature distribution has exceeded optimal parameters, the multi-agent system automatically generates targeted control commands to adjust heating elements and pressure systems. These control commands are transmitted directly to the manufacturing equipment's programmable logic controllers (PLCs), which implement precise adjustments to the vulcanization process parameters. By automatically implementing these corrective actions based on real-time detection of process deviations and their root causes, the system maintains product quality while preventing material waste. The system also modulates the production line speed and adjusts upstream material mixing ratios based on the severity of detected anomalies, implementing a comprehensive control response that spans multiple stages of the manufacturing process. This automated control capability demonstrates tangible improvement to industrial manufacturing technology by applying the abstract analytical outputs to concrete physical process control, resulting in measurable reductions in defect rates and improved production efficiency.

In some examples, the computer enforces privacy compliance by automatically identifying sensitive information within the input data, applying data anonymization to the sensitive information before performing the root cause analysis, and maintaining an audit log of all processing operations performed on the input data. This integrated approach to privacy and compliance is useful for deploying sophisticated AI analysis capabilities in regulated industries such as healthcare, finance, and legal services, where data protection requirements are particularly stringent.

In some examples, at least one of the plurality of agents is configured to analyze domain-specific information using ontologies corresponding to a specific field, and the master analysis engine incorporates the domain-specific information into cross-domain analysis by mapping between different domain ontologies. This ensures that data from different sources can be meaningfully integrated despite variations in original terminology or classification systems.

In some examples, the multi-agent engine dynamically reconfigures the plurality of agents by monitoring effectiveness of each agent in analyzing specific aspects of the input data, identifying knowledge gaps in collective analysis by the plurality of agents, and modifying agent responsibilities or deploying additional specialized agents to address the identified knowledge gaps. This dynamic reconfiguration enables the system to adapt to new data patterns and evolving analytical requirements.

When the iterative processing technique comprises a Fault Tree Analysis that identifies combinations of faults leading to system failures, implementing the Fault Tree Analysis includes constructing a logical diagram that shows the relationship between a potential critical event and its primary and secondary causes, applying Boolean logic to analyze combinations of events that could lead to the detected anomalies, and calculating failure probabilities for different branches of the fault tree to prioritize risk mitigation strategies.

When the iterative processing technique comprises a Bayesian Network analysis that models probabilistic relationships between variables, implementing the Bayesian Network analysis includes constructing a probabilistic graphical model that represents a set of variables and dependencies between variables in the set of variables, generating a belief network based on the probabilistic graphical model, and calculating posterior probabilities to determine the causes of the detected anomalies.

When the iterative processing technique comprises a Failure Mode and Effects Analysis that identifies potential failures and consequences, implementing the Failure Mode and Effects Analysis includes identifying potential failure modes across the multiple data sources, assigning a rating to at least one potential failure mode, the rating being at least one of a severity rating, an occurrence rating, or a detection rating, calculating, based on the assigned rating, a risk priority number for the at least one potential failure mode, and implementing a corrective action when the risk priority number exceeds a threshold.

When the iterative processing technique comprises a Causal Loop Diagram analysis that identifies feedback relationships between variables, implementing the Causal Loop Diagram analysis includes identifying the variables affecting a system state across multiple domains, mapping reinforcing and balancing feedback loops between the variables, quantifying time delays in causal relationships, and identifying leverage points for intervention based on a behavior simulation.

When the iterative processing technique comprises a Granger Causality analysis that determines whether one time series is useful in forecasting another, implementing the Granger Causality analysis includes performing statistical hypothesis tests to determine whether one time series provides statistically significant information (i.e., information that exceeds predetermined confidence thresholds (e.g., p-value < 0.05 or p-value < 0.01)) about future values of another time series, calculating lag periods between potential causes and observed anomalies, applying vector autoregression models to multi-variable time series data, and identifying cross-domain temporal relationships that indicate causality.

In some examples, the trained artificial intelligence model integrates multiple root cause analysis techniques by dynamically selecting analytical techniques based on data characteristics and domain contexts, iteratively applying different root cause analysis methodologies to generate multiple hypothesis sets, reconciling conflicting causal hypotheses through ensemble methods that weight results based on methodology reliability for specific data types, and progressively refining causal relationships through feedback from domain-specific agents and historical accuracy metrics. The artificial intelligence model uses reinforcement learning to optimize methodology selection based on success rates in similar historical cases.

The integration of multiple root cause analysis methodologies may be valuable in complex analytical contexts. For example, the Five Whys technique provides depth by iteratively questioning each detected issue to identify deeper causes, while Ishikawa (Fishbone) Diagrams provide breadth by categorizing multifactorial influences. The Issue-Based Information System (IBIS) enables structured problem-solving discussions among specialized AI agents, systematically refining hypotheses through argumentative structures. Issue Trees decompose complex problems into hierarchical components suitable for distributed analysis, while Why-Because Graphs (WBGs) visually represent causal chains to enhance interpretability and eliminate confounding factors. The system's ability to dynamically select and combine these approaches based on the specific analytical context significantly enhances its problem-solving capabilities across diverse domains.

In some cases, the computer implements an adaptive root cause analysis framework that maintains a knowledge base of historical anomalies and their verified causes, tracks the effectiveness of different root cause analysis methodologies across various anomaly types and domains, automatically selects the most appropriate combination of root cause analysis methodologies based on anomaly characteristics and available data, and continuously improves methodology selection criteria through reinforcement learning techniques applied to resolution outcomes. The adaptive framework implements a multi-armed bandit algorithm to balance exploration of new methodological combinations with exploitation of stored techniques.

When the iterative processing technique comprises an 8D problem-solving methodology that systematically identifies root causes and corrective actions, implementing the 8D problem-solving methodology includes forming a cross-domain team of specialized agents with complementary expertise, deploying interim containment actions to isolate detected anomalies, performing root cause verification through controlled testing of hypothesized causes, implementing permanent corrective actions based on verified root causes, and establishing preventive measures to reduce recurrence of the detected anomalies.

In some examples, performing the root cause analysis further includes implementing counterfactual analysis by simulating behavior with modified conditions to test causal hypotheses, calculating causal effect estimates for each potential root cause, generating what-if scenarios to evaluate alternative explanations for detected anomalies, and validating root cause identifications through comparison of predicted outcomes with historical data. This counterfactual analysis strengthens the validation of identified root causes by testing how well they predict outcomes under various hypothetical conditions.

The multi-agent artificial intelligence system provides several key technical innovations that fundamentally transform how computers process and analyze complex cross-domain data. First, in some examples, the system implements a hierarchical multi-agent design that goes beyond conventional modular approaches. Unlike some schemes where specialized modules work in isolation, the present system, in some implementations, deploys specialized transformer neural networks trained on domain-specific data while preserving temporal and semantic interdependencies across domains. This architecture enables each specialized agent to develop deep domain expertise while the master analysis engine actively coordinates between them, identifying relationships that would remain invisible to any single domain model.

Second, the disclosed system, in some examples, implements a novel iterative feedback mechanism for cross-domain refinement that represents a significant advancement over traditional analytical approaches. The master analysis engine not only aggregates outputs from specialized agents but actively identifies interdependencies between different domains' analyses and generates specific feedback for each specialized model. This feedback is then used to update domain-specific analyses in subsequent iterations, creating a dynamic refinement process that continues until meeting defined convergence criteria. This approach allows the system to progressively build more accurate understandings of complex cross-domain relationships through structured collaboration between specialized AI engines, resulting in analyses that are both more accurate and more comprehensive than would be possible with conventional single-iteration approaches.

Third, in some examples, the system implements unified data standardization with preservation of time-based relationships, addressing a critical technical challenge in processing heterogeneous data. The data standardization engine converts diverse inputs (including scanned documents, structured databases, and streaming data) into standardized formats while explicitly preserving temporal relationships and mapping them to domain-specific ontologies. This approach maintains time-order and semantic context, enabling the system to automatically identify how indicators in one domain causally relate to indicators in another domain, even when these relationships span extended time periods or involve complex interdependencies.

Fourth, in some examples, the system implements automated, multi-method root cause analysis that significantly advances beyond traditional single-methodology approaches. While conventional systems typically apply a single analytical technique uniformly, this system can dynamically select and apply multiple complementary methodologies based on the specific characteristics of the data and anomalies being analyzed. The system integrates outputs from various analytical techniques (such as Five Whys, Ishikawa diagrams, and Bayesian networks) into a unified causal map with quantified likelihood estimates. This ability to seamlessly shift among multiple root cause analysis methods in an automated, coordinated fashion enables more comprehensive and accurate identification of complex causal relationships than would be possible with any single methodology.

Fifth, in some examples, the system implements a scalable privacy and compliance layer that enables sophisticated AI analysis while maintaining strict adherence to regulatory requirements. Unlike conventional approaches that often treat privacy as an afterthought or external constraint, this system integrates privacy protection directly into its processing pipeline. The privacy and compliance engine automatically identifies sensitive information, applies appropriate anonymization techniques, enforces domain-specific privacy rules, and maintains a comprehensive audit trail of all processing operations. This integrated approach ensures that the insights generated by the system are obtained through responsible data processing practices while enabling analysis across highly regulated domains such as healthcare, finance, and legal services.

One aspect of the disclosed system is its sophisticated approach to processing hierarchical indicator structures and their temporal patterns. Unlike schemes that process all data points uniformly, some examples of the disclosed technique distinguish between primary indicators directly associated with domain conditions and secondary indicators that provide indirect evidence of these conditions. This distinction allows each specialist AI model to establish complex dependency networks between primary and secondary indicators, capturing subtle relationships that might otherwise be overlooked. For example, in healthcare applications, a cardiology model would process not only primary cardiac markers but also secondary inflammatory indicators and their temporal progression patterns, enabling the detection of complex cardio-inflammatory relationships that conventional single-focus analysis would miss. This approach fundamentally transforms how computers identify causal relationships in complex domains by accounting for both direct and indirect evidence simultaneously while preserving their hierarchical relationships and temporal evolution.

The system's feedback generation mechanism represents another aspect. Traditional multi-model schemes may combine outputs through simple aggregation or weighted averaging, without a true understanding of interdependencies between different analytical domains. In contrast, according to some examples, the present system implements a sophisticated mechanism where the master analysis model identifies specific interdomain dependencies and generates targeted, customized feedback for each specialist AI model. This feedback is not generic but precisely tailored to address how findings in one domain should influence analyses in another domain. For instance, when analyzing financial anomalies, regulatory insights from a legal AI model are transformed into specific feedback that helps financial models recalibrate their risk assessments. This targeted feedback mechanism enables specialist models to incorporate cross-domain insights in ways that preserve their domain expertise while accounting for external factors, resulting in substantially more accurate and comprehensive analyses than conventional methods.

The system's ability to generate consolidated findings that cohesively integrate analyses across multiple domains overcomes a fundamental limitation of some schemes. Some schemes may produce separate reports for each analytical domain, leaving users to manually identify connections and resolve contradictions between them. However, some examples of the disclosed technology implement a consolidation process that algorithmically resolves conflicts between domain-specific analyses, prioritizes findings based on cross-validated evidence, and identifies causal chains that span multiple domains. This consolidation process preserves the nuanced insights from specialist models while creating a unified analytical framework that reveals complex interdependencies. The resulting consolidated findings represent not just a collection of domain-specific analyses but a truly integrated understanding of the underlying system that accounts for complex interactions between different specialized domains.

The comprehensive analysis report generation capability represents a significant advancement beyond some reporting schemes. Unlike schemes that organize reports by data source or analytical module, in some examples, the disclosed technique implements an adaptive report structure that can organize findings by discipline categories, identified conditions, or temporal patterns based on the specific analytical context and user needs. This approach allows the system to present complex cross-domain relationships in an intuitive manner that highlights critical interdependencies while maintaining temporal context. For example, in a healthcare application, the report might trace how an endocrine abnormality detected years before ultimately contributed to current cardiovascular symptoms, organizing this multi-discipline relationship in a clear causal narrative. This coordinated analysis across disciplines and temporal patterns transforms how complex analytical findings are communicated, making sophisticated multi-domain insights accessible and actionable for users with varying levels of technical expertise.

The multi-agent architecture implements specific technical improvements to overcome limitations in some conventional computing systems. The specialized transformer neural networks utilize a modified attention mechanism that weights cross-domain relationships based on temporal consistency and causal strength, enabling more efficient processing of interdependencies. The system implements a novel convergence algorithm that adaptively adjusts feedback pathways between specialist models based on information gain metrics, preventing computational loops while ensuring comprehensive analysis. These technical implementations enable the system to process significantly larger datasets with improved computational efficiency, typically reducing processing requirements compared to conventional multi-module systems while identifying more valid cross-domain relationships.

The disclosed multi-agent system demonstrates measurable technical improvements over conventional computing systems. In processing electronic health records with a large number (e.g., over 5,000) biomarkers per patient, the system requires fewer computational resources than conventional systems while identifying more clinically relevant cross-domain relationships. In financial analysis applications, the system processes market anomalies across regulatory, economic, and transactional domains with improved processing efficiency and higher accuracy in root cause identification compared to traditional analytical systems. These quantifiable improvements in computational efficiency and analytical accuracy represent specific technical advancements that directly address the limitations of prior computing systems.

Some examples of the disclosed technique provide specific improvements to computer technology itself, rather than merely using computers as tools. The multi-agent architecture transforms how computers process and analyze complex cross-domain data through novel technical mechanisms including: specialized transformer neural networks with modified attention mechanisms, adaptive convergence algorithms that optimize feedback pathways, and hierarchical data structures that explicitly preserve temporal and semantic relationships. These technical features enable computers to perform functions they were not previously capable of—specifically, the efficient processing of massive heterogeneous datasets while automatically identifying complex patterns, relationships, and root causes spanning multiple specialized domains. The technical advancements result in concrete improvements in computational efficiency, data processing capabilities, and analytical accuracy that represent meaningful limitations beyond merely organizing human activity or implementing abstract ideas on generic computer components.

In contrast to some schemes, some examples of the disclosed technique overcome specific technical limitations through its novel architecture. Some machine learning schemes analyze healthcare data within isolated silos—cardiac markers separate from neurological indicators, separate from endocrine measurements—and can only identify correlations within these silos. When presented with a complex patient case involving many (e.g., over 5,000) biomarkers collected over decades, conventional systems either fail to process the full dataset due to computational constraints or miss critical relationships between seemingly unrelated markers. The present system, however, can process the entire dataset while automatically identifying that subtle patterns in thyroid function from fifteen years prior causally relate to current cardiac anomalies through specific inflammatory pathways—a complex cross-temporal, cross-domain relationship that conventional systems cannot detect due to their technical limitations. This capability represents a concrete technical improvement that transforms how computers can analyze complex multifaceted data rather than merely enhancing human analysis through conventional computing means.

The disclosed technique represents a specific technological improvement to computing systems. The hierarchical multi-agent architecture with its specialized transformer neural networks, iterative feedback mechanisms, and temporal-semantic data structures constitutes a particular machine specifically designed to address identified technical problems in cross-domain data processing. The system's ability to automatically normalize heterogeneous data while preserving semantic relationships, track dependencies between specialized analytical modules, and refine analyses through convergent iterative processing represents technological advancements beyond conventional computing capabilities rather than simply automating mental processes or business methods. The specific technical implementations detailed throughout this document transform computing capabilities in ways that could not be performed through mental steps or conventional computing approaches.

Multiple use cases of the disclosed technology are possible. For example, the disclosed technology may be implemented in industrial control environments.

In one implementation, the multi-agent system is deployed in semiconductor fabrication facilities to control photolithography processes. The system continuously monitors and analyzes data from multiple domain-specific subsystems including wafer alignment sensors, photoresist deposition equipment, exposure systems, and development chambers. When the system detects pattern misalignment anomalies during wafer inspection, it performs real-time root cause analysis across all process domains. Upon determining that thermal expansion variations in the silicon substrate are causing the misalignment, the system automatically adjusts temperature control parameters in the pre-exposure chambers, modifies exposure timing sequences, and recalibrates alignment systems by sending direct control commands to the respective equipment controllers. This automated intervention maintains critical nanometer-scale precision in chip fabrication, directly improving manufacturing yield rates and preventing costly production errors. The physical integration between analytical outputs and manufacturing equipment control represents a practical application that transforms abstract data analysis into concrete improvements in semiconductor production technology.

In another implementation, in a chemical processing plant, the multi-agent system monitors continuous flow reactors for pharmaceutical production. By analyzing real-time data from temperature sensors, pressure gauges, flow meters, and chemical composition analyzers, the system detects subtle deviations in reaction kinetics that would typically go unnoticed until final quality testing. When the system identifies an anomalous increase in unwanted byproducts, it traces the causal chain to specific catalyst degradation patterns and automatically adjusts reactor parameters by sending control commands to the processing equipment. These adjustments include precise modifications to inlet flow rates, catalyst injection timing, temperature gradients across reaction chambers, and residence time distributions. The system's direct control of these physical process parameters maintains product purity specifications while optimizing resource utilization. This automated process control capability represents a concrete application that transforms the root cause analysis into tangible improvements in pharmaceutical manufacturing efficiency and product quality.

In another implementation, in a power generation facility, the multi-agent system monitors turbine operation across multiple domains including mechanical vibration analysis, thermal efficiency metrics, and electrical output characteristics. When the system detects anomalous vibration patterns in turbine bearings, it performs cross-domain root cause analysis that correlates the mechanical anomalies with subtle deviations in steam quality and electrical load patterns. Upon determining that transient load variations are causing thermal expansion anomalies that manifest as mechanical vibrations, the system automatically implements a coordinated control response. This response includes adjusting fuel input rates to stabilize thermal conditions, modifying steam valve timing sequences to optimize pressure distributions, and recalibrating electrical load management systems to prevent harmful transients. The system transmits specific control commands directly to the power plant's distributed control systems (DCS), which implement the precise adjustments to multiple physical subsystems. This automated intervention prevents potential equipment damage while optimizing power generation efficiency, demonstrating a practical application that transforms analytical insights into concrete improvements in critical infrastructure operation.

In an advanced manufacturing robotics system, the multi-agent architecture monitors multi-axis robotic assembly operations across mechanical, vision system, control logic, and materials handling domains. When the system detects anomalous assembly error rates during precision component placement, it conducts real-time root cause analysis across all operational domains. Upon determining that subtle deviations in component feeder positions combined with vision system calibration drift are causing the placement errors, the system automatically implements a coordinated control response. This response includes transmitting precise positional correction commands to servo controllers, adjusting computer vision algorithm parameters, modifying pick-and-place motion profiles, and adjusting feeder advancement timing. The system's direct interface with the robotic control systems enables immediate implementation of these adjustments, maintaining production quality without human intervention. This automated control capability represents a concrete implementation that transforms cross-domain analytical insights into specific physical control actions that tangibly improve manufacturing consistency and quality.

In an industrial food processing facility, the multi-agent system monitors continuous heat treatment operations for food safety and quality assurance. By analyzing data from temperature sensors, flow meters, pressure gauges, and composition analyzers, the system detects anomalies in pasteurization effectiveness that could compromise product safety. When the system identifies an anomalous decrease in thermal kill effectiveness, it traces the causal chain through multiple processing domains and determines that pump cavitation combined with heat exchanger scaling is creating inconsistent flow patterns through treatment chambers. The system automatically implements corrective actions by transmitting control commands that adjust pump speeds, modify valve positions to redistribute flow patterns, adjust heating element duty cycles, and recalibrate retention time parameters. These physical system adjustments ensure food safety while optimizing energy utilization. The direct control of these critical process parameters demonstrates a practical application that transforms analytical outputs into concrete actions that tangibly improve food safety and production efficiency.

Some embodiments are described as numbered examples (Example 1, 2, 3, etc.). These are provided as examples only and do not limit the technology disclosed herein.

Example 1 is a method for improving computational efficiency in anomaly detection and root cause analysis, the method comprising: accessing, by one or more processors, input data from multiple data sources in different formats; executing, by the one or more processors, a multi-agent engine to detect anomalies in the input data by: deploying a plurality of agents configured with specialized data processing models, wherein each agent analyzes an aspect of the input data, and coordinating, via a master analysis engine, information exchange between the plurality of agents to standardize the input data into a normalized format to enable cross-domain analysis; performing, by the one or more processors, root cause analysis by: applying an iterative processing technique to identify causes of the detected anomalies in the input data, wherein the iterative processing technique includes, recursively analyzing detected anomalies to trace causal chains across the multiple data sources, and generating a data structure mapping relationships between the detected anomalies and the identified causes, the data structure indicating a likelihood that at least one identified cause is associated with at least one detected anomaly, wherein the likelihood is determined using a trained artificial intelligence model that evaluates temporal correlations between historical anomalies and verified causes, wherein the data structure reduces processing requirements for subsequent anomaly detection operations; and generating, by the one or more processors, an output indicating root causes identified through the root cause analysis, wherein the output includes a real-time alert when the likelihood exceeds a threshold.

In Example 2, the subject matter of Example 1 includes, wherein executing the multi-agent engine comprises: implementing a hierarchical architecture of specialized transformer neural networks, wherein each transformer neural network is trained to process domain-specific data, and wherein the master analysis engine integrates outputs from the specialized transformer neural networks to identify cross-domain patterns and relationships.

In Example 3, the subject matter of Examples 1–2 includes, wherein standardizing the input data into a normalized format comprises: converting heterogeneous data into standardized formats; generating a temporal database that preserves time-based relationships between data elements; and creating a hierarchical data structure that explicitly captures primary indicators, secondary indicators, and interdependencies between the primary indicators and the secondary indicators across the multiple data sources.

In Example 4, the subject matter of Examples 1–3 includes, wherein each agent of the plurality of agents processes both primary indicators directly related to conditions of interest and secondary indicators having indirect relationships to the conditions of interest, the method further comprising: identifying relationships across multiple domains associated with at least a subset of the plurality of agents.

In Example 5, the subject matter of Examples 1–4 includes, wherein the trained artificial intelligence model comprises transformer neural networks trained through an iterative process using training data comprising domain-specific literature and expert-validated analysis patterns.

In Example 6, the subject matter of Examples 1–5 includes, wherein performing the root cause analysis further comprises: identifying interdependencies between analyses by at least a subset of the plurality of agents; generating additional data for at least one agent of the plurality of agents based on the identified interdependencies; and updating, by the at least one agent, a domain-specific analysis based on the additional data until meeting a convergence criterion.

In Example 7, the subject matter of Examples 1–6 includes, wherein the data structure mapping relationships includes cross-domain dependencies, wherein the cross-domain dependencies indicate a relationship between a first anomaly in a first domain and a factor in a second domain different from the first domain.

In Example 8, the subject matter of Examples 1–7 includes, wherein the iterative processing technique comprises at least one of: a Five Whys analysis that recursively questions each detected anomaly, an Ishikawa diagram analysis that categorizes multifactorial influences contributing to detected anomalies, an Issue-Based Information System that structures agent discussions for systematic hypothesis refinement, an Issue Tree analysis that decomposes complex problems into hierarchical components, a Why-Because Graph that represents the causal chains for enhanced interpretability, a Fault Tree Analysis that identifies combinations of faults leading to system failures, a Causal Loop Diagram analysis that identifies feedback relationships between variables, a Bayesian Network analysis that models probabilistic relationships between variables, an Event Chain Methodology that analyzes sequences of events and their relationships, a Failure Mode and Effects Analysis that identifies potential failures and consequences, a Granger Causality analysis that determines whether one time series is useful in forecasting another, an Eight Disciplines (8D) problem-solving methodology that systematically identifies root causes and corrective actions, or a Factor Analysis that identifies underlying factors influencing observed variables.

In Example 9, the subject matter of Examples 1–8 includes, wherein coordinating the information exchange between the plurality of agents comprises: assigning confidence scores to insights generated by each agent; weighting the insights based on the assigned confidence scores; and adjusting agent processing priorities based on historical accuracy of insights from each agent.

In Example 10, the subject matter of Examples 1–9 includes, wherein the data structure mapping relationships between the detected anomalies and the at least one identified cause comprises a directed graph having nodes representing the detected anomalies and the at least one identified cause, and edges representing causal relationships between the nodes, wherein each edge is associated with the likelihood determined by the trained artificial intelligence model.

In Example 11, the subject matter of Examples 1–10 includes, tracking temporal dependencies by establishing time-sequenced event correlations across the multiple data sources; and incorporating the temporal dependencies into the data structure to reflect cause-effect relationships that occur over different time periods.

In Example 12, the subject matter of Examples 1–11 includes, wherein generating the output further comprises: customizing the output based on recipient expertise level; generating visualizations of the data structure mapping relationships between the detected anomalies and the identified causes; and providing interactive controls enabling drill-down exploration of the causal chains.

In Example 13, the subject matter of Examples 1–12 includes, enforcing privacy compliance by: automatically identifying sensitive information within the input data; applying data anonymization to the sensitive information before performing the root cause analysis; and maintaining an audit log of all processing operations performed on the input data.

In Example 14, the subject matter of Examples 1–13 includes, wherein at least one of the plurality of agents is configured to analyze domain-specific information using ontologies corresponding to a specific field, and wherein the master analysis engine incorporates the domain-specific information into cross-domain analysis by mapping between different domain ontologies.

In Example 15, the subject matter of Examples 1–14 includes, wherein the multi-agent engine dynamically reconfigures the plurality of agents by: monitoring effectiveness of each agent in analyzing specific aspects of the input data; identifying knowledge gaps in collective analysis by the plurality of agents; and modifying agent responsibilities or deploying additional specialized agents to address the identified knowledge gaps.

In Example 16, the subject matter of Examples 1–15 includes, wherein the iterative processing technique comprises a Fault Tree Analysis that identifies combinations of faults leading to system failures, wherein implementing the Fault Tree Analysis comprises: constructing a logical diagram that shows the relationship between a potential critical event and its primary and secondary causes; applying Boolean logic to analyze combinations of events that could lead to the detected anomalies; and calculating failure probabilities for different branches of the fault tree to prioritize risk mitigation strategies.

In Example 17, the subject matter of Examples 1–16 includes, wherein the iterative processing technique comprises a Bayesian Network analysis that models probabilistic relationships between variables, wherein implementing the Bayesian Network analysis comprises: constructing a probabilistic graphical model that represents a set of variables and dependencies between variables in the set of variables; generating a belief network based on the probabilistic graphical model; and calculating posterior probabilities to determine the causes of the detected anomalies.

In Example 18, the subject matter of Examples 1–17 includes, wherein the iterative processing technique comprises a Failure Mode and Effects Analysis that identifies potential failures and consequences, wherein implementing the Failure Mode and Effects Analysis comprises: identifying potential failure modes across the multiple data sources; assigning a rating to at least one potential failure mode, the rating being at least one of a severity rating, an occurrence rating, or a detection rating; calculating, based on the assigned rating, a risk priority number for the at least one potential failure mode; and implementing a corrective action when the risk priority number exceeds a threshold.

In Example 19, the subject matter of Examples 1–18 includes, wherein the iterative processing technique comprises a Causal Loop Diagram analysis that identifies feedback relationships between variables, wherein implementing the Causal Loop Diagram analysis comprises: identifying the variables affecting a system state across multiple domains; mapping reinforcing and balancing feedback loops between the variables; quantifying time delays in causal relationships; and identifying leverage points for intervention based on a behavior simulation.

In Example 20, the subject matter of Examples 1–19 includes, wherein the iterative processing technique comprises a Granger Causality analysis that determines whether one time series is useful in forecasting another, wherein implementing the Granger Causality analysis comprises: performing statistical hypothesis tests to determine whether one time series provides statistically significant information about future values of another time series; calculating lag periods between potential causes and observed anomalies; applying vector autoregression models to multi-variable time series data; and identifying cross-domain temporal relationships that indicate causality.

In Example 21, the subject matter of Examples 1–20 includes, wherein the trained artificial intelligence model integrates multiple root cause analysis techniques by: dynamically selecting analytical techniques based on data characteristics and domain contexts; iteratively applying different root cause analysis methodologies to generate multiple hypothesis sets; reconciling conflicting causal hypotheses through ensemble methods that weight results based on methodology reliability for specific data types; and progressively refining causal relationships through feedback from domain-specific agents and historical accuracy metrics, wherein the artificial intelligence model uses reinforcement learning to optimize methodology selection based on success rates in similar historical cases.

In Example 22, the subject matter of Examples 1–21 includes, implementing an adaptive root cause analysis framework that: maintains a knowledge base of historical anomalies and their verified causes; tracks the effectiveness of different root cause analysis methodologies across various anomaly types and domains; automatically selects the most appropriate combination of root cause analysis methodologies based on anomaly characteristics and available data; and continuously improves methodology selection criteria through reinforcement learning techniques applied to resolution outcomes, wherein the adaptive framework implements a multi-armed bandit algorithm to balance exploration of new methodological combinations with exploitation of stored techniques.

In Example 23, the subject matter of Examples 1–22 includes, D) problem-solving methodology comprises: forming a cross-domain team of specialized agents with complementary expertise; deploying interim containment actions to isolate detected anomalies; performing root cause verification through controlled testing of hypothesized causes; implementing permanent corrective actions based on verified root causes; and establishing preventive measures to reduce recurrence of the detected anomalies.

In Example 24, the subject matter of Examples 1–23 includes, wherein performing the root cause analysis further comprises implementing counterfactual analysis by: simulating behavior with modified conditions to test causal hypotheses, calculating causal effect estimates for each potential root cause, generating what-if scenarios to evaluate alternative explanations for detected anomalies, and validating root cause identifications through comparison of predicted outcomes with historical data.

Example 25 is a non-transitory computer-readable medium for improving computational efficiency in anomaly detection and root cause analysis, the non-transitory computer-readable medium storing instructions operable to cause one or more processors to perform operations comprising: accessing, by the one or more processors, input data from multiple data sources in different formats; executing, by the one or more processors, a multi-agent engine to detect anomalies in the input data by: deploying a plurality of agents configured with specialized data processing models, wherein each agent analyzes an aspect of the input data, and coordinating, via a master analysis engine, information exchange between the plurality of agents to standardize the input data into a normalized format to enable cross-domain analysis; performing, by the one or more processors, root cause analysis by: applying an iterative processing technique to identify causes of the detected anomalies in the input data, wherein the iterative processing technique includes, recursively analyzing detected anomalies to trace causal chains across the multiple data sources, and generating a data structure mapping relationships between the detected anomalies and the identified causes, the data structure indicating a likelihood that at least one identified cause is associated with at least one detected anomaly, wherein the likelihood is determined using a trained artificial intelligence model that evaluates temporal correlations between historical anomalies and verified causes, wherein the data structure reduces processing requirements for subsequent anomaly detection operations; and generating, by the one or more processors, an output indicating root causes identified through the root cause analysis, wherein the output includes a real-time alert when the likelihood exceeds a threshold.

In Example 26, the subject matter of Example 25 includes, wherein executing the multi-agent engine comprises: implementing a hierarchical architecture of specialized transformer neural networks, wherein each transformer neural network is trained to process domain-specific data, and wherein the master analysis engine integrates outputs from the specialized transformer neural networks to identify cross-domain patterns and relationships.

In Example 27, the subject matter of Examples 25–26 includes, wherein standardizing the input data into a normalized format comprises: converting heterogeneous data into standardized formats; generating a temporal database that preserves time-based relationships between data elements; and creating a hierarchical data structure that explicitly captures primary indicators, secondary indicators, and interdependencies between the primary indicators and the secondary indicators across the multiple data sources.

In Example 28, the subject matter of Examples 25–27 includes, wherein each agent of the plurality of agents processes both primary indicators directly related to conditions of interest and secondary indicators having indirect relationships to the conditions of interest, the operations further comprising: identifying relationships across multiple domains associated with at least a subset of the plurality of agents.

In Example 29, the subject matter of Examples 25–28 includes, wherein the trained artificial intelligence model comprises transformer neural networks trained through an iterative process using training data comprising domain-specific literature and expert-validated analysis patterns.

In Example 30, the subject matter of Examples 25–29 includes, wherein performing the root cause analysis further comprises: identifying interdependencies between analyses by at least a subset of the plurality of agents; generating additional data for at least one agent of the plurality of agents based on the identified interdependencies; and updating, by the at least one agent, a domain-specific analysis based on the additional data until meeting a convergence criterion.

In Example 31, the subject matter of Examples 25–30 includes, wherein the data structure mapping relationships includes cross-domain dependencies, wherein the cross-domain dependencies indicate a relationship between a first anomaly in a first domain and a factor in a second domain different from the first domain.

In Example 32, the subject matter of Examples 25–31 includes, wherein the iterative processing technique comprises at least one of: a Five Whys analysis that recursively questions each detected anomaly, an Ishikawa diagram analysis that categorizes multifactorial influences contributing to detected anomalies, an Issue-Based Information System that structures agent discussions for systematic hypothesis refinement, an Issue Tree analysis that decomposes complex problems into hierarchical components, a Why-Because Graph that represents the causal chains for enhanced interpretability, a Fault Tree Analysis that identifies combinations of faults leading to system failures, a Causal Loop Diagram analysis that identifies feedback relationships between variables, a Bayesian Network analysis that models probabilistic relationships between variables, an Event Chain Methodology that analyzes sequences of events and their relationships, a Failure Mode and Effects Analysis that identifies potential failures and consequences, a Granger Causality analysis that determines whether one time series is useful in forecasting another, an Eight Disciplines (8D) problem-solving methodology that systematically identifies root causes and corrective actions, or a Factor Analysis that identifies underlying factors influencing observed variables.

In Example 33, the subject matter of Examples 25–32 includes, wherein coordinating the information exchange between the plurality of agents comprises: assigning confidence scores to insights generated by each agent; weighting the insights based on the assigned confidence scores; and adjusting agent processing priorities based on historical accuracy of insights from each agent.

In Example 34, the subject matter of Examples 25–33 includes, wherein the data structure mapping relationships between the detected anomalies and the at least one identified cause comprises a directed graph having nodes representing the detected anomalies and the at least one identified cause, and edges representing causal relationships between the nodes, wherein each edge is associated with the likelihood determined by the trained artificial intelligence model.

In Example 35, the subject matter of Examples 25–34 includes, tracking temporal dependencies by establishing time-sequenced event correlations across the multiple data sources; and incorporating the temporal dependencies into the data structure to reflect cause-effect relationships that occur over different time periods.

In Example 36, the subject matter of Examples 25–35 includes, wherein generating the output further comprises: customizing the output based on recipient expertise level; generating visualizations of the data structure mapping relationships between the detected anomalies and the identified causes; and providing interactive controls enabling drill-down exploration of the causal chains.

In Example 37, the subject matter of Examples 25–36 includes, enforcing privacy compliance by: automatically identifying sensitive information within the input data; applying data anonymization to the sensitive information before performing the root cause analysis; and maintaining an audit log of all processing operations performed on the input data.

In Example 38, the subject matter of Examples 25–37 includes, wherein at least one of the plurality of agents is configured to analyze domain-specific information using ontologies corresponding to a specific field, and wherein the master analysis engine incorporates the domain-specific information into cross-domain analysis by mapping between different domain ontologies.

In Example 39, the subject matter of Examples 25–38 includes, wherein the multi-agent engine dynamically reconfigures the plurality of agents by: monitoring effectiveness of each agent in analyzing specific aspects of the input data; identifying knowledge gaps in collective analysis by the plurality of agents; and modifying agent responsibilities or deploying additional specialized agents to address the identified knowledge gaps.

In Example 40, the subject matter of Examples 25–39 includes, wherein the iterative processing technique comprises a Fault Tree Analysis that identifies combinations of faults leading to system failures, wherein implementing the Fault Tree Analysis comprises: constructing a logical diagram that shows the relationship between a potential critical event and its primary and secondary causes; applying Boolean logic to analyze combinations of events that could lead to the detected anomalies; and calculating failure probabilities for different branches of the fault tree to prioritize risk mitigation strategies.

In Example 41, the subject matter of Examples 25–40 includes, wherein the iterative processing technique comprises a Bayesian Network analysis that models probabilistic relationships between variables, wherein implementing the Bayesian Network analysis comprises: constructing a probabilistic graphical model that represents a set of variables and dependencies between variables in the set of variables; generating a belief network based on the probabilistic graphical model; and calculating posterior probabilities to determine the causes of the detected anomalies.

In Example 42, the subject matter of Examples 25–41 includes, wherein the iterative processing technique comprises a Failure Mode and Effects Analysis that identifies potential failures and consequences, wherein implementing the Failure Mode and Effects Analysis comprises: identifying potential failure modes across the multiple data sources; assigning a rating to at least one potential failure mode, the rating being at least one of a severity rating, an occurrence rating, or a detection rating; calculating, based on the assigned rating, a risk priority number for the at least one potential failure mode; and implementing a corrective action when the risk priority number exceeds a threshold.

In Example 43, the subject matter of Examples 25–42 includes, wherein the iterative processing technique comprises a Causal Loop Diagram analysis that identifies feedback relationships between variables, wherein implementing the Causal Loop Diagram analysis comprises: identifying the variables affecting a system state across multiple domains; mapping reinforcing and balancing feedback loops between the variables; quantifying time delays in causal relationships; and identifying leverage points for intervention based on a behavior simulation.

In Example 44, the subject matter of Examples 25–43 includes, wherein the iterative processing technique comprises a Granger Causality analysis that determines whether one time series is useful in forecasting another, wherein implementing the Granger Causality analysis comprises: performing statistical hypothesis tests to determine whether one time series provides statistically significant information about future values of another time series; calculating lag periods between potential causes and observed anomalies; applying vector autoregression models to multi-variable time series data; and identifying cross-domain temporal relationships that indicate causality.

In Example 45, the subject matter of Examples 25–44 includes, wherein the trained artificial intelligence model integrates multiple root cause analysis techniques by: dynamically selecting analytical techniques based on data characteristics and domain contexts; iteratively applying different root cause analysis methodologies to generate multiple hypothesis sets; reconciling conflicting causal hypotheses through ensemble methods that weight results based on methodology reliability for specific data types; and progressively refining causal relationships through feedback from domain-specific agents and historical accuracy metrics, wherein the artificial intelligence model uses reinforcement learning to optimize methodology selection based on success rates in similar historical cases.

In Example 46, the subject matter of Examples 25–45 includes, implementing an adaptive root cause analysis framework that: maintains a knowledge base of historical anomalies and their verified causes; tracks the effectiveness of different root cause analysis methodologies across various anomaly types and domains; automatically selects the most appropriate combination of root cause analysis methodologies based on anomaly characteristics and available data; and continuously improves methodology selection criteria through reinforcement learning techniques applied to resolution outcomes, wherein the adaptive framework implements a multi-armed bandit algorithm to balance exploration of new methodological combinations with exploitation of stored techniques.

In Example 47, the subject matter of Examples 25–46 includes, D) problem-solving methodology comprises: forming a cross-domain team of specialized agents with complementary expertise; deploying interim containment actions to isolate detected anomalies; performing root cause verification through controlled testing of hypothesized causes; implementing permanent corrective actions based on verified root causes; and establishing preventive measures to reduce recurrence of the detected anomalies.

In Example 48, the subject matter of Examples 25–47 includes, wherein performing the root cause analysis further comprises implementing counterfactual analysis by: simulating behavior with modified conditions to test causal hypotheses, calculating causal effect estimates for each potential root cause, generating what-if scenarios to evaluate alternative explanations for detected anomalies, and validating root cause identifications through comparison of predicted outcomes with historical data.

Example 49 is a system for improving computational efficiency in anomaly detection and root cause analysis, the system comprising: one or more processors; and a memory subsystem storing instructions operable to cause the one or more processors to perform operations comprising: accessing, by the one or more processors, input data from multiple data sources in different formats; executing, by the one or more processors, a multi-agent engine to detect anomalies in the input data by: deploying a plurality of agents configured with specialized data processing models, wherein each agent analyzes an aspect of the input data, and coordinating, via a master analysis engine, information exchange between the plurality of agents to standardize the input data into a normalized format to enable cross-domain analysis; performing, by the one or more processors, root cause analysis by: applying an iterative processing technique to identify causes of the detected anomalies in the input data, wherein the iterative processing technique includes, recursively analyzing detected anomalies to trace causal chains across the multiple data sources, and generating a data structure mapping relationships between the detected anomalies and the identified causes, the data structure indicating a likelihood that at least one identified cause is associated with at least one detected anomaly, wherein the likelihood is determined using a trained artificial intelligence model that evaluates temporal correlations between historical anomalies and verified causes, wherein the data structure reduces processing requirements for subsequent anomaly detection operations; and generating, by the one or more processors, an output indicating root causes identified through the root cause analysis, wherein the output includes a real-time alert when the likelihood exceeds a threshold.

In Example 50, the subject matter of Example 49 includes, wherein executing the multi-agent engine comprises: implementing a hierarchical architecture of specialized transformer neural networks, wherein each transformer neural network is trained to process domain-specific data, and wherein the master analysis engine integrates outputs from the specialized transformer neural networks to identify cross-domain patterns and relationships.

In Example 51, the subject matter of Examples 49–50 includes, wherein standardizing the input data into a normalized format comprises: converting heterogeneous data into standardized formats; generating a temporal database that preserves time-based relationships between data elements; and creating a hierarchical data structure that explicitly captures primary indicators, secondary indicators, and interdependencies between the primary indicators and the secondary indicators across the multiple data sources.

In Example 52, the subject matter of Examples 49–51 includes, wherein each agent of the plurality of agents processes both primary indicators directly related to conditions of interest and secondary indicators having indirect relationships to the conditions of interest, the operations further comprising: identifying relationships across multiple domains associated with at least a subset of the plurality of agents.

In Example 53, the subject matter of Examples 49–52 includes, wherein the trained artificial intelligence model comprises transformer neural networks trained through an iterative process using training data comprising domain-specific literature and expert-validated analysis patterns.

In Example 54, the subject matter of Examples 49–53 includes, wherein performing the root cause analysis further comprises: identifying interdependencies between analyses by at least a subset of the plurality of agents; generating additional data for at least one agent of the plurality of agents based on the identified interdependencies; and updating, by the at least one agent, a domain-specific analysis based on the additional data until meeting a convergence criterion.

In Example 55, the subject matter of Examples 49–54 includes, wherein the data structure mapping relationships includes cross-domain dependencies, wherein the cross-domain dependencies indicate a relationship between a first anomaly in a first domain and a factor in a second domain different from the first domain.

In Example 56, the subject matter of Examples 49–55 includes, wherein the iterative processing technique comprises at least one of: a Five Whys analysis that recursively questions each detected anomaly, an Ishikawa diagram analysis that categorizes multifactorial influences contributing to detected anomalies, an Issue-Based Information System that structures agent discussions for systematic hypothesis refinement, an Issue Tree analysis that decomposes complex problems into hierarchical components, a Why-Because Graph that represents the causal chains for enhanced interpretability, a Fault Tree Analysis that identifies combinations of faults leading to system failures, a Causal Loop Diagram analysis that identifies feedback relationships between variables, a Bayesian Network analysis that models probabilistic relationships between variables, an Event Chain Methodology that analyzes sequences of events and their relationships, a Failure Mode and Effects Analysis that identifies potential failures and consequences, a Granger Causality analysis that determines whether one time series is useful in forecasting another, an Eight Disciplines (8D) problem-solving methodology that systematically identifies root causes and corrective actions, or a Factor Analysis that identifies underlying factors influencing observed variables.

In Example 57, the subject matter of Examples 49–56 includes, wherein coordinating the information exchange between the plurality of agents comprises: assigning confidence scores to insights generated by each agent; weighting the insights based on the assigned confidence scores; and adjusting agent processing priorities based on historical accuracy of insights from each agent.

In Example 58, the subject matter of Examples 49–57 includes, wherein the data structure mapping relationships between the detected anomalies and the at least one identified cause comprises a directed graph having nodes representing the detected anomalies and the at least one identified cause, and edges representing causal relationships between the nodes, wherein each edge is associated with the likelihood determined by the trained artificial intelligence model.

In Example 59, the subject matter of Examples 49–58 includes, tracking temporal dependencies by establishing time-sequenced event correlations across the multiple data sources; and incorporating the temporal dependencies into the data structure to reflect cause-effect relationships that occur over different time periods.

In Example 60, the subject matter of Examples 49–59 includes, wherein generating the output further comprises: customizing the output based on recipient expertise level; generating visualizations of the data structure mapping relationships between the detected anomalies and the identified causes; and providing interactive controls enabling drill-down exploration of the causal chains.

In Example 61, the subject matter of Examples 49–60 includes, enforcing privacy compliance by: automatically identifying sensitive information within the input data; applying data anonymization to the sensitive information before performing the root cause analysis; and maintaining an audit log of all processing operations performed on the input data.

In Example 62, the subject matter of Examples 49–61 includes, wherein at least one of the plurality of agents is configured to analyze domain-specific information using ontologies corresponding to a specific field, and wherein the master analysis engine incorporates the domain-specific information into cross-domain analysis by mapping between different domain ontologies.

In Example 63, the subject matter of Examples 49–62 includes, wherein the multi-agent engine dynamically reconfigures the plurality of agents by: monitoring effectiveness of each agent in analyzing specific aspects of the input data; identifying knowledge gaps in collective analysis by the plurality of agents; and modifying agent responsibilities or deploying additional specialized agents to address the identified knowledge gaps.

In Example 64, the subject matter of Examples 49–63 includes, wherein the iterative processing technique comprises a Fault Tree Analysis that identifies combinations of faults leading to system failures, wherein implementing the Fault Tree Analysis comprises: constructing a logical diagram that shows the relationship between a potential critical event and its primary and secondary causes; applying Boolean logic to analyze combinations of events that could lead to the detected anomalies; and calculating failure probabilities for different branches of the fault tree to prioritize risk mitigation strategies.

In Example 65, the subject matter of Examples 49–64 includes, wherein the iterative processing technique comprises a Bayesian Network analysis that models probabilistic relationships between variables, wherein implementing the Bayesian Network analysis comprises: constructing a probabilistic graphical model that represents a set of variables and dependencies between variables in the set of variables; generating a belief network based on the probabilistic graphical model; and calculating posterior probabilities to determine the causes of the detected anomalies.

In Example 66, the subject matter of Examples 49–65 includes, wherein the iterative processing technique comprises a Failure Mode and Effects Analysis that identifies potential failures and consequences, wherein implementing the Failure Mode and Effects Analysis comprises: identifying potential failure modes across the multiple data sources; assigning a rating to at least one potential failure mode, the rating being at least one of a severity rating, an occurrence rating, or a detection rating; calculating, based on the assigned rating, a risk priority number for the at least one potential failure mode; and implementing a corrective action when the risk priority number exceeds a threshold.

In Example 67, the subject matter of Examples 49–66 includes, wherein the iterative processing technique comprises a Causal Loop Diagram analysis that identifies feedback relationships between variables, wherein implementing the Causal Loop Diagram analysis comprises: identifying the variables affecting a system state across multiple domains; mapping reinforcing and balancing feedback loops between the variables; quantifying time delays in causal relationships; and identifying leverage points for intervention based on a behavior simulation.

In Example 68, the subject matter of Examples 49–67 includes, wherein the iterative processing technique comprises a Granger Causality analysis that determines whether one time series is useful in forecasting another, wherein implementing the Granger Causality analysis comprises: performing statistical hypothesis tests to determine whether one time series provides statistically significant information about future values of another time series; calculating lag periods between potential causes and observed anomalies; applying vector autoregression models to multi-variable time series data; and identifying cross-domain temporal relationships that indicate causality.

In Example 69, the subject matter of Examples 49–68 includes, wherein the trained artificial intelligence model integrates multiple root cause analysis techniques by: dynamically selecting analytical techniques based on data characteristics and domain contexts; iteratively applying different root cause analysis methodologies to generate multiple hypothesis sets; reconciling conflicting causal hypotheses through ensemble methods that weight results based on methodology reliability for specific data types; and progressively refining causal relationships through feedback from domain-specific agents and historical accuracy metrics, wherein the artificial intelligence model uses reinforcement learning to optimize methodology selection based on success rates in similar historical cases.

In Example 70, the subject matter of Examples 49–69 includes, implementing an adaptive root cause analysis framework that: maintains a knowledge base of historical anomalies and their verified causes; tracks the effectiveness of different root cause analysis methodologies across various anomaly types and domains; automatically selects the most appropriate combination of root cause analysis methodologies based on anomaly characteristics and available data; and continuously improves methodology selection criteria through reinforcement learning techniques applied to resolution outcomes, wherein the adaptive framework implements a multi-armed bandit algorithm to balance exploration of new methodological combinations with exploitation of stored techniques.

In Example 71, the subject matter of Examples 49–70 includes, D) problem-solving methodology comprises: forming a cross-domain team of specialized agents with complementary expertise; deploying interim containment actions to isolate detected anomalies; performing root cause verification through controlled testing of hypothesized causes; implementing permanent corrective actions based on verified root causes; and establishing preventive measures to reduce recurrence of the detected anomalies.

In Example 72, the subject matter of Examples 49–71 includes, wherein performing the root cause analysis further comprises implementing counterfactual analysis by: simulating behavior with modified conditions to test causal hypotheses, calculating causal effect estimates for each potential root cause, generating what-if scenarios to evaluate alternative explanations for detected anomalies, and validating root cause identifications through comparison of predicted outcomes with historical data.

Example 73 is at least one machine-readable medium including instructions that, when executed by processing circuitry, cause the processing circuitry to perform operations to implement any of Examples 1–72.

Example 74 is an apparatus comprising means to implement any of Examples 1–72.

Example 75 is a system to implement any of Examples 1–72.

Example 76 is a method to implement any of Examples 1–72.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms "a" or "an" are used, as is common in patent documents, to include one or more than one, independent of any other instances or usages of "at least one" or "one or more." In this document, the term "or" is used to refer to a nonexclusive or, such that "A or B" includes "A but not B," "B but not A," and "A and B," unless otherwise indicated. In this document, the terms "including" and "in which" are used as the plain-English equivalents of the respective terms "comprising" and "wherein." Also, in the following claims, the terms "including" and "comprising" are open-ended, that is, a system, user equipment (UE), article, composition, formulation, or process that includes elements in addition to those listed after such a term in a claim are still deemed to fall within the scope of that claim. Moreover, in the following claims, the terms "first," "second," and "third," etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for improving computational efficiency in anomaly detection and root cause analysis, the method comprising:
accessing, by one or more processors, input data from multiple data sources in different formats;
executing, by the one or more processors, a multi-agent engine to detect anomalies in the input data by:
deploying a plurality of agents configured with specialized data processing models, wherein each agent analyzes an aspect of the input data, and
coordinating, via a master analysis engine, information exchange between the plurality of agents to standardize the input data into a normalized format to enable cross-domain analysis;
performing, by the one or more processors, root cause analysis by:
applying an iterative processing technique to identify causes of the detected anomalies in the input data, wherein the iterative processing technique includes recursively analyzing detected anomalies to trace causal chains across the multiple data sources, and
generating a data structure mapping relationships between the detected anomalies and the identified causes, the data structure indicating a likelihood that at least one identified cause is associated with at least one detected anomaly, wherein the likelihood is determined using a trained artificial intelligence model that evaluates temporal correlations between historical anomalies and verified causes, wherein the data structure reduces processing requirements for subsequent anomaly detection operations; and
generating, by the one or more processors, an output indicating root causes identified through the root cause analysis, wherein the output includes a real-time alert when the likelihood exceeds a threshold.

2. The method of claim 1, wherein executing the multi-agent engine comprises:
implementing a hierarchical architecture of specialized transformer neural networks, wherein each transformer neural network is trained to process domain-specific data, and wherein the master analysis engine integrates outputs from the specialized transformer neural networks to identify cross-domain patterns and relationships.

3. The method of claim 1, wherein standardizing the input data into a normalized format comprises:
converting heterogeneous data into standardized formats;
generating a temporal database that preserves time-based relationships between data elements; and
creating a hierarchical data structure that explicitly captures primary indicators, secondary indicators, and interdependencies between the primary indicators and the secondary indicators across the multiple data sources.

4. The method of claim 1, wherein each agent of the plurality of agents processes both primary indicators directly related to conditions of interest and secondary indicators having indirect relationships to the conditions of interest, the method further comprising:
identifying relationships across multiple domains associated with at least a subset of the plurality of agents.

5. The method of claim 1, wherein the trained artificial intelligence model comprises transformer neural networks trained through an iterative process using training data comprising domain-specific literature and expert-validated analysis patterns.

6. The method of claim 1, wherein performing the root cause analysis further comprises:
identifying interdependencies between analyses by at least a subset of the plurality of agents;
generating additional data for at least one agent of the plurality of agents based on the identified interdependencies; and
updating, by the at least one agent, a domain-specific analysis based on the additional data until meeting a convergence criterion.

7. The method of claim 1, wherein the data structure mapping relationships includes cross-domain dependencies, wherein the cross-domain dependencies indicate a relationship between a first anomaly in a first domain and a factor in a second domain different from the first domain.

8. The method of claim 1, wherein the iterative processing technique comprises at least one of:
a Five Whys analysis that recursively questions each detected anomaly,
an Ishikawa diagram analysis that categorizes multifactorial influences contributing to detected anomalies,
an Issue-Based Information System that structures agent discussions for systematic hypothesis refinement,
an Issue Tree analysis that decomposes complex problems into hierarchical components,
a Why-Because Graph that represents the causal chains for enhanced interpretability,
a Fault Tree Analysis that identifies combinations of faults leading to system failures,
a Causal Loop Diagram analysis that identifies feedback relationships between variables,
a Bayesian Network analysis that models probabilistic relationships between variables,
an Event Chain Methodology that analyzes sequences of events and their relationships,
a Failure Mode and Effects Analysis that identifies potential failures and consequences,
a Granger Causality analysis that determines whether one time series is useful in forecasting another,
an Eight Disciplines (8D) problem-solving methodology that systematically identifies root causes and corrective actions, or
a Factor Analysis that identifies underlying factors influencing observed variables.

9. The method of claim 1, wherein coordinating the information exchange between the plurality of agents comprises:
assigning confidence scores to insights generated by each agent;
weighting the insights based on the assigned confidence scores; and
adjusting agent processing priorities based on historical accuracy of insights from each agent.

10. The method of claim 1, wherein the data structure mapping relationships between the detected anomalies and the at least one identified cause comprises a directed graph having nodes representing the detected anomalies and the at least one identified cause, and edges representing causal relationships between the nodes, wherein each edge is associated with the likelihood determined by the trained artificial intelligence model.

11. A non-transitory computer-readable medium for improving computational efficiency in anomaly detection and root cause analysis, the non-transitory computer-readable medium storing instructions operable to cause one or more processors to perform operations comprising:
accessing, by the one or more processors, input data from multiple data sources in different formats;
executing, by the one or more processors, a multi-agent engine to detect anomalies in the input data by:
deploying a plurality of agents configured with specialized data processing models, wherein each agent analyzes an aspect of the input data, and
coordinating, via a master analysis engine, information exchange between the plurality of agents to standardize the input data into a normalized format to enable cross-domain analysis;
performing, by the one or more processors, root cause analysis by:
applying an iterative processing technique to identify causes of the detected anomalies in the input data, wherein the iterative processing technique includes recursively analyzing detected anomalies to trace causal chains across the multiple data sources, and
generating a data structure mapping relationships between the detected anomalies and the identified causes, the data structure indicating a likelihood that at least one identified cause is associated with at least one detected anomaly, wherein the likelihood is determined using a trained artificial intelligence model that evaluates temporal correlations between historical anomalies and verified causes, wherein the data structure reduces processing requirements for subsequent anomaly detection operations; and
generating, by the one or more processors, an output indicating root causes identified through the root cause analysis, wherein the output includes a real-time alert when the likelihood exceeds a threshold.

12. The non-transitory computer-readable medium of claim 11, further comprising:
tracking temporal dependencies by establishing time-sequenced event correlations across the multiple data sources; and
incorporating the temporal dependencies into the data structure to reflect cause-effect relationships that occur over different time periods.

13. The non-transitory computer-readable medium of claim 11, wherein generating the output further comprises:
customizing the output based on recipient expertise level;
generating visualizations of the data structure mapping relationships between the detected anomalies and the identified causes; and
providing interactive controls enabling drill-down exploration of the causal chains.

14. The non-transitory computer-readable medium of claim 11, further comprising enforcing privacy compliance by:
automatically identifying sensitive information within the input data;
applying data anonymization to the sensitive information before performing the root cause analysis; and
maintaining an audit log of all processing operations performed on the input data.

15. The non-transitory computer-readable medium of claim 11, wherein at least one of the plurality of agents is configured to analyze domain-specific information using ontologies corresponding to a specific field, and wherein the master analysis engine incorporates the domain-specific information into cross-domain analysis by mapping between different domain ontologies.

16. The non-transitory computer-readable medium of claim 11, wherein the multi-agent engine dynamically reconfigures the plurality of agents by:
monitoring effectiveness of each agent in analyzing specific aspects of the input data;
identifying knowledge gaps in collective analysis by the plurality of agents; and
modifying agent responsibilities or deploying additional specialized agents to address the identified knowledge gaps.

17. A system for improving computational efficiency in anomaly detection and root cause analysis, the system comprising:
one or more processors; and
a memory subsystem storing instructions operable to cause the one or more processors to perform operations comprising:
accessing, by the one or more processors, input data from multiple data sources in different formats;
executing, by the one or more processors, a multi-agent engine to detect anomalies in the input data by:
deploying a plurality of agents configured with specialized data processing models, wherein each agent analyzes an aspect of the input data, and
coordinating, via a master analysis engine, information exchange between the plurality of agents to standardize the input data into a normalized format to enable cross-domain analysis;
performing, by the one or more processors, root cause analysis by:
applying an iterative processing technique to identify causes of the detected anomalies in the input data, wherein the iterative processing technique includes recursively analyzing detected anomalies to trace causal chains across the multiple data sources, and
generating a data structure mapping relationships between the detected anomalies and the identified causes, the data structure indicating a likelihood that at least one identified cause is associated with at least one detected anomaly, wherein the likelihood is determined using a trained artificial intelligence model that evaluates temporal correlations between historical anomalies and verified causes, wherein the data structure reduces processing requirements for subsequent anomaly detection operations; and
generating, by the one or more processors, an output indicating root causes identified through the root cause analysis, wherein the output includes a real-time alert when the likelihood exceeds a threshold.

18. The system of claim 17, wherein the iterative processing technique comprises a Fault Tree Analysis that identifies combinations of faults leading to system failures, wherein implementing the Fault Tree Analysis comprises:
constructing a logical diagram that shows the relationship between a potential critical event and its primary and secondary causes;
applying Boolean logic to analyze combinations of events that could lead to the detected anomalies; and
calculating failure probabilities for different branches of the fault tree to prioritize risk mitigation strategies.

19. The system of claim 17, wherein the iterative processing technique comprises a Bayesian Network analysis that models probabilistic relationships between variables, wherein implementing the Bayesian Network analysis comprises:
constructing a probabilistic graphical model that represents a set of variables and dependencies between variables in the set of variables;
generating a belief network based on the probabilistic graphical model; and
calculating posterior probabilities to determine the causes of the detected anomalies.

20. The system of claim 17, wherein the iterative processing technique comprises a Failure Mode and Effects Analysis that identifies potential failures and consequences, wherein implementing the Failure Mode and Effects Analysis comprises:
identifying potential failure modes across the multiple data sources;
assigning a rating to at least one potential failure mode, the rating being at least one of a severity rating, an occurrence rating, or a detection rating;
calculating, based on the assigned rating, a risk priority number for the at least one potential failure mode; and
implementing a corrective action when the risk priority number exceeds a threshold.
